(19) United States
(12) Patent Application Publication
(10) Pub. No.: US 2020/0231797 A1
(43) Pub. Date: Jul. 23, 2020

(54) COMPOSITION AND COATING FILM

(71) Applicant: DAIKIN INDUSTRIES, LTD., Osaka-Shi, Osaka (JP)

(72) Inventors: Yasukazu NAKATANI, Osaka-Shi, Osaka (JP); Koichiro OGITA, Osaka-Shi, Osaka (JP); Katsuhiko IMOTO, Osaka-Shi, Osaka (JP)

(73) Assignee: DAIKIN INDUSTRIES, LTD., Osaka-Shi, Osaka (JP)

(21) Appl. No.: 16/483,224

(22) PCT Filed: Jan. 24, 2018
(86) PCT No.: PCT/JP2018/002105

§ 371 Date: Aug. 2, 2019

(30) Foreign Application Priority Data
Feb. 3, 2017 (JP) 2017-018727

(51) Int. Cl. C08L 27/18; C09D 127/18; C08L 27/12; C09D 127/12

(52) U.S. Cl. CPC C08L 27/18; C09D 127/12; C08L 27/12; C09D 127/18

(57) ABSTRACT

A composition including a polymer and at least one compound selected from a reactive polydialkylsiloxane and a fluoropolyether, the polymer containing a perhaloolefin unit and a hydroxy group-containing monomer unit and having a hydroxyl value of 110 to 210 mgKOH/g.

### TECHNICAL FIELD

The invention relates to compositions and coating films.

### BACKGROUND ART

Fluorine-containing copolymers soluble in organic solvents or water and crosslinkable at room temperature have a high bond energy of an intramolecular C—F bond and low polarizability. Such fluorine-containing copolymers have excellent properties such as weather resistance, chemical resistance, water and oil repellency, and stain resistance, and are used for various applications.

For example, Patent Literature 1 discloses a back sheet for a solar cell module, including a substrate sheet and, on one or both sides of the substrate sheet, a cured coating film layer formed from a coating material containing a fluoropolymer (A) that contains a repeating unit based on a fluoroolefin (a), a repeating unit based on a crosslinkable group-containing monomer (b), and a repeating unit based on an alkyl group-containing monomer (c) in which a C2-C20 linear or branched alkyl group free from a quaternary carbon atom and a polymerizable unsaturated group are linked via an ether bond or an ester bond.

### CITATION LIST

### Patent Literature

Patent Literature 1: WO 2009/157449

### SUMMARY OF INVENTION

### Technical Problem

However, coating films need to have further improved weather resistance and stain resistance.

In view of the current state of the art described above, the invention aims to provide a composition that provides a coating film having excellent weather resistance and stain resistance and the coating film.

### Solution to Problem

The invention relates to a composition including:

a polymer, and

at least one compound selected from the group consisting of a reactive polydialkylsiloxane and a fluoropolyether,

the polymer containing a unit of a perhaloolefin and a unit of a hydroxy group-containing monomer and having a hydroxyl value of 110 to 210 mgKOH/g.

The perhaloolefin is preferably at least one selected from the group consisting of tetrafluoroethylene, chlorotrifluoroethylene, and hexafluoropropylene.

The hydroxy group-containing monomer is preferably a hydroxyalkyl vinyl ether.

The polymer preferably further contains a unit of a vinyl ester that contains neither a hydroxy group nor an aromatic ring.

The vinyl ester is preferably at least one selected from the group consisting of vinyl acetate, vinyl propionate, vinyl butyrate, vinyl isobutyrate, vinyl pivalate, vinyl caproate, vinyl versatate, vinyl laurate, vinyl stearate, and vinyl cyclohexylcarboxylate.

The reactive polydialkylsiloxane preferably contains no polyether group.

The reactive polydialkylsiloxane is preferably at least one selected from the group consisting of: a compound represented by the following formula (I):

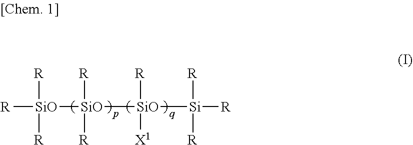

wherein each R is independently a C1-C8 alkyl group or an aryl group;

X¹ is

—R^{L}—NH₂,

—R^{L}—NH—R^{a1}—NH₂, where R^{a1} is an alkylene group,

—R^{L}−OR^{a2}, where R^{a2} is H or an alkyl group,

—R^{L}—CR^{a3} (R^{a4}OH)₂, where R^{a3} is an alkyl group and R^{a4} is an alkylene group,

—R^{L}—Ar¹—OR^{a5}, where Ar¹ is an arylene group and R^{a5} is H or an alkyl group,

—R^{L}—O(C═O)—CR^{a6}═CH₂, where R^{a6} is H or an alkyl group,

—R^{L}—SH,

—R^{L}—COOR^{a7}, where R^{a7} is H or an alkyl group,

—H,

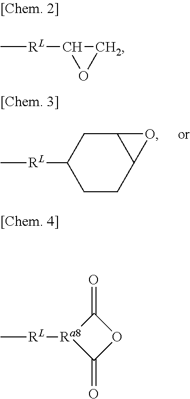

wherein R^{a8} is a trivalent hydrocarbon group,

wherein each R^{L} is a single bond or an alkylene group not containing two or more ether bonds, with any of X¹s being optionally —R^{L}—(C₂H₄O)ₐ(C₃H₆O)_{b}—R^{a9}, wherein R^{L} is as defined above, R^{a9} is an alkyl group, a is an integer of 0 to 50, and b is an integer of 0 to 50, with a+b being an integer of 2 or greater; p is an integer of 0 to 100000; and q is an integer of 1 to 100000: and

a compound represented by the following formula (II):

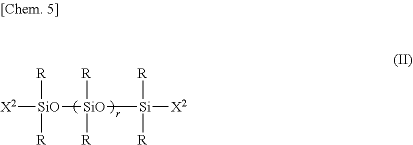

wherein each R is as defined above; each X² is independently the same as X¹ defined above or —R^{L}— (C₂H₄O)ₐ(C₃H₆O)_{b}—H (R^{L}, a, and b are as defined above); and r is an integer of 1 to 100000.

The reactive polydialkylsiloxane preferably has a specific gravity of 0.80 to 1.15.

The reactive polydialkylsiloxane preferably has a refractive index of 1.370 to 1.540.

The fluoropolyether is preferably a compound represented by the formula:

R¹¹—(R¹²O)ₙ—R¹³

wherein R¹¹ and R¹³ are each independently H, F, a C1-C16 alkyl group, a C1-C16 alkoxy group, a C1-C16 fluorinated alkyl group, a C1-C16 fluorinated alkoxy group, or —R¹⁴—X¹¹ (R¹⁴ is a single bond or a divalent organic group, X¹¹ is —NH₂, —OH, —COOH, —CH═CH₂, —OCH₂CH═CH₂, a halogen atom, a phosphate group, an organophosphate group, an alkoxycarbonyl group, a thiol group, a thioether group, an aryl group, an aryl ether group, or an amino group); R¹² is a C1-C4 fluorinated alkylene group; and n is an integer of 2 or greater.

The composition preferably further contains a polyisocyanate compound.

The composition preferably further contains a solvent.

The invention also relates to a coating film formed from the composition.

### ADVANTAGEOUS EFFECTS OF INVENTION

The composition of the invention having any of the features described above can provide a coating film having excellent weather resistance and stain resistance.

The coating film of the invention having any of the features described above has excellent weather resistance and stain resistance.

### DESCRIPTION OF EMBODIMENTS

The invention will specifically be described hereinbelow.

The composition of the invention contains a polymer. The composition having such a feature can provide a coating film having excellent weather resistance and stain resistance. The composition can be suitably used as a coating material.

The polymer has a feature that it has a hydroxyl value of 110 to 210 mgKOH/g. The hydroxyl value is preferably 115 mgKOH/g or greater, more preferably 120 mgKOH/g or greater, while preferably 200 mgKOH/g or smaller, more preferably 180 mgKOH/g or smaller.

The hydroxyl value is calculated from the weight of the polymer and the number of moles of the —OH group. The number of moles of the —OH group may be determined by NMR analysis, IR analysis, titration, or elementary analysis, for example.

The polymer contains a unit of a perhaloolefin and a unit of a hydroxy group-containing monomer.

The perhaloolefin providing the perhaloolefin unit may be an olefin in which all hydrogen atoms are replaced with halogen atoms. Examples of the perhaloolefin providing the perhaloolefin unit include tetrafluoroethylene (TFE), chlorotrifluoroethylene (CTFE), hexafluoropropylene (HFP), and perfluoro(alkyl vinyl ether).

In particular, the perhaloolefin is preferably at least one selected from the group consisting of TFE, CTFE, and HFP, more preferably at least one selected from the group consisting of TFE and CTFE.

The hydroxy group-containing monomer providing the hydroxy group-containing monomer unit is preferably at least one selected from the group consisting of hydroxyalkyl vinyl ethers, hydroxyalkyl allyl ethers, vinyl hydroxycarboxylates, allyl hydroxycarboxylates, and hydroxyalkyl(meth)acrylates, more preferably at least one selected from the group consisting of hydroxyalkyl vinyl ethers and hydroxyalkyl allyl ethers, still more preferably hydroxyalkyl vinyl ethers.

Examples of the hydroxyalkyl vinyl ethers include 2-hydroxyethyl vinyl ether, 3-hydroxypropyl vinyl ether, 2-hydroxypropyl vinyl ether, 2-hydroxy-2-methylpropyl vinyl ether, 4-hydroxybutyl vinyl ether, 4-hydroxy-2-methylbutyl vinyl ether, 5-hydroxypentyl vinyl ether, and 6-hydroxyhexyl vinyl ether.

Examples of the hydroxyalkyl allyl ethers include 2-hydroxyethyl allyl ether, 4-hydroxybutyl allyl ether, and glycerol monoallyl ether.

Examples of the vinyl hydroxycarboxylates include vinyl hydroxyacetate, vinyl hydroxypropanoate, vinyl hydroxybutanoate, vinyl hydroxyhexanoate, and vinyl(4-hydroxycyclohexyl)acetate.

Examples of the allyl hydroxycarboxylates include allyl hydroxyacetate, allyl hydroxypropanoate, allyl hydroxybutanoate, allyl hydroxyhexanoate, and allyl(4-hydroxycyclohexyl)acetate.

Examples of the hydroxyalkyl(meth)acrylates include 2-hydroxyethyl acrylate and 2-hydroxyethyl methacrylate.

In particular, the hydroxy group-containing monomer is still more preferably one represented by the formula (A):

CH₂═CH—(CH₂)₁—O—(CH₂)ₘ—OH

(wherein 1 is 0 or 1 and m is an integer of 2 to 20), particularly preferably at least one monomer selected from the group consisting of 4-hydroxybutyl vinyl ether, 2-hydroxyethyl vinyl ether, 2-hydroxyethyl allyl ether, and 4-hydroxybutyl allyl ether.

The amount of the perhaloolefin unit is preferably 30 to 90 mol %, more preferably 30 to 60 mol %, still more preferably 40 to 55 mol % of all monomer units constituting the polymer.

The amount of the hydroxy group-containing monomer unit is preferably 10 to 70 mol %, more preferably 10 to 40 mol %, still more preferably 15 to 40 mol %, further more preferably 15 to 35 mol %, particularly preferably 20 to 35 mol % of all monomer units constituting the polymer.

Herein, the amounts of the monomer units constituting the polymer may be calculated by any appropriate combination of NMR, FT-IR, elementary analysis, and X-ray fluorescence analysis in accordance with the types of the monomers.

The polymer preferably further contains a unit of a vinyl ester that contains neither a hydroxy group nor an aromatic ring.

The vinyl ester providing the vinyl ester unit is preferably a vinyl carboxylate, more preferably at least one selected from the group consisting of vinyl acetate, vinyl propionate, vinyl butyrate, vinyl isobutyrate, vinyl pivalate, vinyl caproate, vinyl versatate, vinyl laurate, vinyl stearate, and vinyl cyclohexylcarboxylate, still more preferably at least one selected from the group consisting of vinyl acetate, vinyl versatate, vinyl laurate, vinyl stearate, and vinyl cyclohexylcarboxylate, particularly preferably at least one selected from the group consisting of vinyl acetate and vinyl versatate.

In order to obtain much better adhesiveness and abrasion resistance, the vinyl ester is preferably a vinyl carboxylate in which the carboxylic acid has a carbon number of 6 or greater, more preferably a vinyl carboxylate in which the carboxylic acid has a carbon number of 9 or greater. The upper limit of the carbon number of the carboxylic acid in the vinyl carboxylate is preferably 20, more preferably 15. In order to obtain excellent adhesiveness to an encapsulant layer, the vinyl ester is most preferably a vinyl versatate such as vinyl neononanoate or vinyl neodecanoate.

The vinyl ester contains neither a hydroxy group nor an aromatic ring. Preferably, the vinyl ester contains no halogen atom.

The amount of the vinyl ester unit that contains neither a hydroxy group nor an aromatic ring is preferably 1 to 40 mol %, more preferably 1 to 35 mol %, still more preferably 10 to 30 mol % of all monomer units constituting the polymer.

The polymer may further contain a monomer unit other than the perhaloolefin unit, the hydroxy group-containing monomer unit, and the vinyl ester unit that contains neither a hydroxy group nor an aromatic ring. For example, the polymer may contain any of the units of an aromatic ring-containing, hydroxy group-free vinyl carboxylate, a carboxy group-containing monomer, an amino group-containing monomer, a hydrolyzable silyl group-containing monomer, a hydroxy group-free alkyl vinyl ether, and a halogen atom- and hydroxy group-free olefin. The amount of the monomer unit(s) may be 0 to 10 mol %, preferably 0.1 to 5 mol %, more preferably 0.5 to 3 mol % of all monomer units constituting the polymer.

Examples of the aromatic ring-containing, hydroxy group-free vinyl carboxylate include vinyl benzoate and vinyl para-t-butyl benzoate.

The carboxy group-containing monomer is preferably one represented by the formula (B):

R^{1a}R^{2a}C═CR^{3a}—(CH₂)ₙ—COOH

(wherein R^{1a}, R^{2a}, and R^{3a} are the same as or different from each other, and are each a hydrogen atom or a C1-C10 linear or branched alkyl group; and n is an integer of 0 or greater). Examples thereof include acrylic acid, methacrylic acid, vinylacetic acid, crotonic acid, pentenoic acid, hexenoic acid, heptenoic acid, octenoic acid, nonenoic acid, decenoic acid, undecylenic acid, dodecenoic acid, tridecenoic acid, tetradecenoic acid, pentadecenoic acid, hexadecenoic acid, heptadecenoic acid, octadecenoic acid, nonadecenoic acid, eicosenoic acid, and 22-tricosenoic acid. In particular, preferred is at least one selected from the group consisting of acrylic acid, crotonic acid, and undecylenic acid, and more preferred is at least one selected from the group consisting of acrylic acid and crotonic acid.

Examples of the carboxy group-containing monomer also include cinnamic acid, 3-allyloxy propionic acid, itaconic acid, itaconic acid monoester, maleic acid, maleic acid monoester, maleic anhydride, fumaric acid, fumaric acid monoester, vinyl phthalate, vinyl pyromellitate, citraconic acid, mesaconic acid, and aconitic acid.

Examples of the amino group-containing monomer include amino vinyl ethers represented by CH₂═CH—O—(CH₂)ₓ—NH₂ (x=0 to 10), amines represented by CH₂═CH—O—CO(CH₂)ₓ—NH₂ (x=1 to 10), aminomethylstyrene, vinylamine, acrylamide, vinylacetamide, and vinylformamide.

Examples of the hydrolyzable silyl group-containing monomer include (meth)acrylic acid esters such as CH₂═CHCO₂(CH₂)₃Si (OCH₃)₃, CH₂═CHCO₂(CH₂)₃Si (OC₂H₅)₃, CH₂═C(CH₃) CO₂(CH₂)₃Si (OCH₃)₃, CH₂═C (CH₃)CO₂(CH₂)₃Si (OC₂H₅)₃, CH₂═CHCO₂(CH₂)₃SiCH₃(OC₂H₅)₂, CH₂═C(CH₃)CO₂(CH₂)₃SiC₂H₅(OCH₃)₂, CH₂═C(CH₃)CO₂(CH₂)₃Si(CH₃)₂(OC₂H₅), CH₂═C(CH₃)CO₂(CH₂)₃Si(CH₃)₂OH, CH₂═CH(CH₂)₃Si(OCOCH₃)₃, CH₂═C (CH₃)CO₂(CH₂)₃SiC₂H₅(OCOCH₃)₂, CH₂═C (CH₃)CO₂(CH₂)₃SiCH₃(N(CH₃)COCH₃)₂, CH₂═CHCO₂(CH₂)₃SiCH₃[ON(CH₃)C₂H₅]₂, and CH₂═C(CH₃)CO₂(CH₂)₃SiC₆H₅[ON(CH₃)C₂H₅]₂; vinyl silanes such as CH₂═CHSi[ON═C(CH₃)(C₂H₅)]₃, CH₂═CHSi(OCH₃)₃, CH₂═CHSi(OC₂H₅)₃, CH₂═CHSiCH₃(OCH₃)₂, CH₂═CHSi(OCOCH₃)₃, CH₂═CHSi(CH₃)₂(OC₂H₅), CH₂═CHSi(CH₃)₂SiCH₃(OCH₃)₂, CH₂═CHSiC₂H₅(OCOCH₃)₂, CH₂═CHSiCH₃[ON(CH₃)C₂H₅]₂, and vinyltrichlorosilane and partial hydrolysates thereof; and vinyl ethers such as trimethoxysilylethyl vinyl ether, triethoxysilylethyl vinyl ether, trimethoxysilylbutyl vinyl ether, methyldimethoxysilylethyl vinyl ether, trimethoxysilylpropyl vinyl ether, and triethoxysilylpropyl vinyl ether.

Examples of the hydroxy group-free alkyl vinyl ether include methyl vinyl ether, ethyl vinyl ether, n-propyl vinyl ether, n-butyl vinyl ether, octadecyl vinyl ether, 2-ethylhexyl vinyl ether, cyclohexyl vinyl ether, isopropyl vinyl ether, and isobutyl vinyl ether. In particular, preferred is at least one selected from the group consisting of ethyl vinyl ether and cyclohexyl vinyl ether.

Examples of the olefin include fluorine-free olefins such as ethylene, propylene, n-butene, and isobutene.

The polymer preferably contains at least one unit (b) selected from the group consisting of a vinyl ester unit that contains neither a hydroxy group nor an aromatic ring and an alkyl vinyl ether unit that contains no hydroxy group. The vinyl ester and alkyl vinyl ether are preferably free from a halogen atom.

When the polymer contains the unit (b), the amount of the unit (b) is preferably 1 to 40 mol %, more preferably 1 to 35 mol %, still more preferably 10 to 30 mol % of all monomer units constituting the polymer.

The polymer preferably has a number average molecular weight of 3000 to 100000. The number average molecular weight is more preferably 5000 or higher, still more preferably 8000 or higher, while more preferably 50000 or lower, still more preferably 35000 or lower. Too low a number average molecular weight may cause a failure in providing a coating film having excellent weather resistance, solvent resistance, and stain resistance, as well as high hardness. Too high a number average molecular weight may cause an increase in viscosity of the coating material, leading to difficulty in handling of the coating material. The number average molecular weight may be determined by gel permeation chromatography (GPC) using tetrahydrofuran as an eluent.

The polymer preferably has a glass transition temperature (second run) of 10° C. to 70° C., more preferably 15° C. to 60° C., measured using a differential scanning calorimeter (DSC). Too low a glass transition temperature may cause poor weather resistance, solvent resistance, and stain resistance and may cause a failure in providing a coating film having high hardness. Too high a glass transition temperature may cause an increase in viscosity of the coating material, leading to difficulty in handling of the coating material.

In order to achieve good miscibility with substances such as polyisocyanate compounds and pigments, the polymer preferably has an acid value of 0.6 to 28.8 mgKOH/g, more preferably 2 to 12 mgKOH/g.

The polymer can be produced by solution polymerization, emulsion polymerization, suspension polymerization, or bulk polymerization, and is preferably produced by solution polymerization.

The polymer is preferably produced by polymerizing monomers of the above units through solution polymerization using an organic solvent and a polymerization initiator. The polymerization temperature is usually 0° C. to 150° C., preferably 5° C. to 95° C. The polymerization pressure is usually 0.1 to 10 MPaG (1 to 100 kgf/cm²G).

Examples of the organic solvent include esters such as methyl acetate, ethyl acetate, propyl acetate, n-butyl acetate, and tert-butyl acetate; ketones such as acetone, methyl ethyl ketone, and cyclohexanone; aliphatic hydrocarbons such as hexane, cyclohexane, octane, nonane, decane, undecane, dodecane, and mineral spirits; aromatic hydrocarbons such as benzene, toluene, xylene, naphthalene, and solvent naphtha; alcohols such as methanol, ethanol, tert-butanol, iso-propanol, and ethylene glycol monoalkyl ethers; cyclic ethers such as tetrahydrofuran, tetrahydropyran, and dioxane; and dimethyl sulfoxide, and mixtures thereof.

Examples of the polymerization initiator include persulfates such as ammonium persulfate and potassium persulfate (optionally in combination with any of reducing agents such as sodium hydrogen sulfite, sodium pyrosulfite, cobalt naphthenate, and dimethyl aniline); redox initiators including an oxidizing agent (e.g., ammonium peroxide or potassium peroxide) and a reducing agent (e.g., sodium sulfite) or a transition metal salt (e.g., iron sulfate); diacyl peroxides such as acetyl peroxide and benzoyl peroxide; dialkoxycarbonyl peroxides such as isopropoxycarbonyl peroxide and tert-butoxycarbonyl peroxide; ketone peroxides such as methyl ethyl ketone peroxide and cyclohexanone peroxide; hydroperoxides such as hydrogen peroxide, tert-butyl hydroperoxide, and cumene hydroperoxide; dialkyl peroxides such as di-tert-butyl peroxide and dicumyl peroxide; alkyl peroxy esters such as tert-butyl peroxyacetate and tert-butyl peroxypivalate; and azo compounds such as 2,2′-azobisisobutyronitrile, 2,2′-azobis(2,4-dimethylvaleronitrile), 2,2′-azobis(2-methylvaleronitrile), 2,2′-azobis(2-cyclopropylpropionitrile), 2,2′-azobis-dimethyl isobutyrate, 2,2′-azobis[2-(hydroxymethyl)propionitrile], and 4,4′-azobis(4-cyanopentenoic acid).

The composition of the invention further contains at least one compound selected from the group consisting of a reactive polydialkylsiloxane and a fluoropolyether. The composition having such a feature can provide a coating film having excellent weather resistance and stain resistance.

The reactive polydialkylsiloxane is a polydialkylsiloxane containing a reactive site at an end of the main chain and/or in a side chain. Examples of the reactive site include an amino group-containing site, a hydroxy group-containing site (the hydroxy group excludes the hydroxy group of the carboxy group, the same applies to the following), an alkoxy group-containing site (the alkoxy group excludes the alkoxy group of the alkoxycarbonyl group, the same applies to the following), a mercapto group-containing site, a carboxy group-containing site, an alkoxycarbonyl group-containing site, an epoxy group-containing site, a (meth)acryloyloxy group-containing site, a carboxylic acid anhydride group-containing site, and a hydrogen atom directly binding to a silicon atom. In particular, an amino group-containing site and a hydroxy group-containing site are preferred.

The reactive polydialkylsiloxane preferably contains the reactive site at each end of the main chain and/or in a side chain.

The reactive polydialkylsiloxane may contain a polyether group as long as it contains the reactive site. It preferably contains no polyether group.

The reactive polydialkylsiloxane is preferably a reactive polydimethylsiloxane.

The reactive polydialkylsiloxane is preferably at least one selected from the group consisting of: a compound represented by the following formula (I):

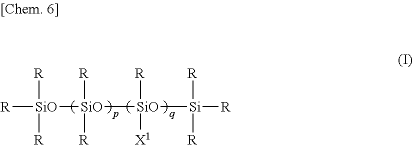

wherein each R is independently a C1-C8 alkyl group or an aryl group;

X¹ is

—R^{L}—NH₂,

—R^{L}—NH—R^{a1}—NH₂, where R^{a1} is an alkylene group,

—R^{L}—OR^{a2}, where R^{a2} is H or an alkyl group,

—R^{L}—CR^{a3}(R^{a4}OH)₂, where R^{a3} is an alkyl group and R^{a4} is an alkylene group,

—R^{L}—Ar¹ —OR^{a5}, where Ar¹ is an arylene group and R^{a5} is H or an alkyl group,

—R^{L}—O(C═O)—CR^{a6}═CH₂, where R^{a6} is H or an alkyl group,

—R^{L}—SH,

—R^{L}—COOR^{a7}, where R^{a7} is H or an alkyl group,

—H,

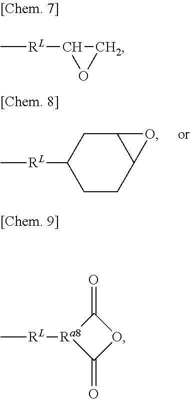

wherein R^{a8} is a trivalent hydrocarbon group, wherein each R^{L} is a single bond or an alkylene group not containing two or more ether bonds, with any of X¹s being optionally —R^{L}—(C₂H₄O)ₐ(C₃H₆O)_{b}—R^{a9}, wherein R^{L} is as defined above, R^{a9} is an alkyl group, a is an integer of 0 to 50, and b is an integer of 0 to 50, with a +b being an integer of 2 or greater; p is an integer of 0 to 100000; and q is an integer of 1 to 100000: and a compound represented by the following formula (II):

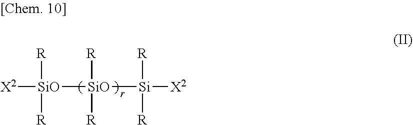

wherein each R is as defined above; each X² is independently the same as X¹ defined above or —R^{L}—(C₂H₄O)ₐ(C₃H₆O)_{b}—H(R^{L}, a, and b are as defined above); and r is an integer of 1 to 100000.

Each R is independently a C1-C8 alkyl group or an aryl group. The C1-C8 alkyl group is preferably a methyl group or an ethyl group, more preferably a methyl group. The aryl group is preferably a phenyl group. Each R is preferably a methyl group.

Each R^{L} is a single bond or an alkylene group not containing two or more ether bonds. The alkylene group not containing two or more ether bonds is preferably —CH₂—, —CH₂CH₂—, —CH₂CH₂CH₂—, or —CH₂C(CH₃)H—.

In —R^{L}—NH—R^{a1}—NH₂, R^{a1} is an alkylene group. R^{a1} is preferably —CH₂CH₂—, —CH₂—, or —CH₂CH₂CH₂—, more preferably —CH₂CH₂—.

In —R^{L}—OR^{a2}, R^{a2} is H or an alkyl group. The alkyl group is preferably a methyl group. R^{a2} is preferably H.

In —R^{L}—CR^{a3}(R^{a4}OH)₂, R^{a3} is an alkyl group, preferably a methyl group. R^{a4} is an alkylene group, preferably a methylene group.

In —R^{L}—Ar¹—OR^{a5}, Ar¹ is an arylene group. Ar¹ is preferably a phenylene group. R^{a5} is H or an alkyl group. The alkyl group is preferably a methyl group. R^{a5} is preferably H.

In —R^{L}—O(C═O)—CR^{a6}═CH₂, R^{a6} is H or an alkyl group. The alkyl group is preferably a methyl group or an ethyl group. R^{a6} is preferably H or a methyl group.

In —R^{L}—COOR^{a7}, R^{a7} is H or an alkyl group. The alkyl group is preferably a methyl group. R^{a7} is preferably H.

In the formula:

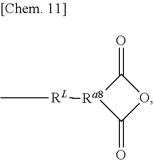

R^{a8} is a trivalent hydrocarbon group, preferably a methine group.

In the formula (I), X¹s may be the same as or different from each other. Any of X¹s may be optionally —R^{L}—(C₂H₄O)ₐ(C₃H₆O)_{b}—R^{a9}. R^{L} is as defined above; R^{a9} is an alkyl group, preferably a methyl group; a is an integer of 0 to 50; and b is an integer of 0 to 50. Here, a+b is an integer of 2 or greater, preferably an integer of 2 to 50.

In the formula (I), p is an integer of 0 to 100000, preferably an integer of 0 to 10000; and q is an integer of 1 to 100000, preferably an integer of 1 to 10000.

In the formula (I), the repeating units may be present in any order.

X¹ is preferably —R^{L}—NH₂, —R^{L}—NH—R^{a1}—NH₂,

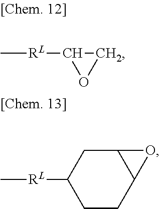

—R^{h}—OH, —R^{L}—SH, —R^{L}—COOH, or —H, more preferably —R^{L}—NH₂, —R^{L}—NH—R^{a1}—NH₂, or —R^{L}—OH.

In the formula (II), each X² is independently the same as X¹ defined above or —R^{L}—(C₂H₄O)ₐ(C₃H₆O)_{b}—H. Specifically, each X² is independently

—R^{L}—NH₂,

—R^{L}—NH—R^{a1}—NH₂,

—R^{L}—OR^{a2},

—R^{L}—CR^{a3}(R^{a4}OH)₂,

—R^{L}—Ar¹—OR^{a5},

—R^{L}—O(C═O)—CR^{a6}═CH₂,

—R^{L}—SH,

—R^{L}—COOR^{a7},

—H,

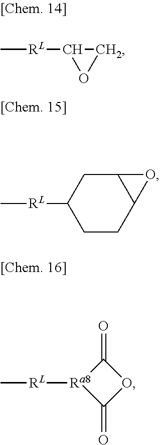

or

—R^{L}—(C₂H₄O)ₐ (C₃H₆O)_{b}—H (in the formulas, R^{L}, R^{a1}, R^{a2}, R^{a3}, R^{a4}, Ar¹, R^{a5}, R^{a6}, R^{a7}, R^{a8}, a, and b are as defined above).

X² is preferably —R^{L}—NH₂, —R^{L}—NH—R^{a1}—NH₂,

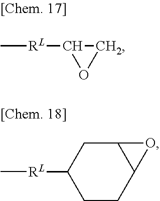

—R^{L}—OH, —R^{L}—SH, —R^{L}—COOH, or —H, more preferably —R^{L}—NH₂, —R^{L}—NH—R^{a1}—NH₂, or —R^{L}—OH.

In the formula (II), the two X²s are preferably the same as each other.

In the formula (II), r is an integer of 1 to 100000, preferably an integer of 1 to 10000.

The reactive polydialkylsiloxane is preferably at least one selected from the group consisting of a compound represented by the formula (I) where X¹ is —R^{L}—NH₂ or —R^{L}—NH—R^{a1}—NH₂ and a compound represented by the formula (II) where each of the two X²s is —R^{L}—OH.

The reactive polydialkylsiloxane preferably has a specific gravity of 0.80 to 1.15, more preferably 0.85 to 1.10.

The specific gravity can be determined according to JIS B 7525-3 using a hydrometer-type relative density meter.

The reactive polydialkylsiloxane preferably has a refractive index of 1.370 to 1.540, more preferably 1.400 to 1.510.

The refractive index may be determined by the method according to JIS K 0062 using the sodium D line.

The fluoropolyether is a compound containing a fluoropolyether group. The fluoropolyether is preferably a compound represented by the formula:

R¹¹—(R¹²O)ₙ—R¹³

wherein R¹¹ and R¹³ are each independently H, F, a C1-C16 alkyl group, a C1-C16 alkoxy group, a C1-C16 fluorinated alkyl group, a C1-C16 fluorinated alkoxy group, or —R¹⁴—X¹¹ (R¹⁴ is a single bond or a divalent organic group, X¹¹ is —NH₂, —OH, —COOH, —CH═CH₂, —OCH₂CH═CH₂, a halogen atom, a phosphate group, an organophosphate group, an alkoxycarbonyl group, a thiol group, a thioether group, an aryl group, an aryl ether group, or an amino group); R¹² is a C1-C4 fluorinated alkylene group; and n is an integer of 2 or greater.

The fluoropolyether is more preferably a compound represented by the formula:

R¹¹¹—(R¹¹²O)ₘ—R¹¹³

(wherein R¹¹¹ and R¹¹³ are each independently F, a C1-C16 alkyl group, a C1-C16 alkoxy group, a C1-C16 fluorinated alkyl group, a C1-C16 fluorinated alkoxy group, or —R¹¹⁴—X111 (R¹¹⁴ is a single bond or a divalent organic group, and X¹¹¹ is —NH₂, —OH, —COOH, —CH═CH₂, —OCH₂CH═CH₂, a halogen, phosphoric acid, a phosphoric acid ester, a carboxylic acid ester, a thiol, a thioether, an alkyl ether (optionally substituted with fluorine), an aryl, an aryl ether, or an amide); R¹¹² is a C1-C4 fluorinated alkylene group; and m is an integer of 2 or greater). In order to impart water repellency, oil repellency, and antifouling properties, X¹¹¹ is preferably at least one selected from the group consisting of —NH₂, —OH, —COOH, a thiol (—SH), —CH═CH₂, and —OCH₂CH═CH₂, more preferably at least one selected from the group consisting of —NH₂, —OH, —COOH, and —OCH₂CH═CH₂, more preferably at least one selected from the group consisting of —NH₂ and —OH. Examples of the divalent organic group include an alkylene group, a fluorinated alkylene group, and a group in which an oxygen atom binds to an end of one of these groups. The divalent organic group may contain any number of carbon atoms. The number of carbon atoms may be 1 to 16, for example.

R¹¹¹ and R¹¹³ are preferably each independently F, a C1-C3 alkyl group, a C1-C3 fluorinated alkyl group, or —R¹¹⁴—X¹¹¹ (R¹¹⁴ and X¹¹¹ are as described above), more preferably F, a C1-C3 perfluorinated alkyl group, or —R¹¹⁴—X¹¹¹ (R¹¹⁴ and X¹¹¹ are as described above).

The subscript m is preferably an integer of 300 or smaller, more preferably an integer of 100 or smaller.

R¹¹² is preferably a C1-C4 perfluorinated alkylene group. Examples of —R¹¹²O— include one represented by the formula:

(CX¹¹²₂CF₂CF₂O)ₙ₁₁₁(CF(CF₃)CF₂O)ₙ₁₁₂(CF₂CF₂O)ₙ₁₁₃(CF₂O)ₙ₁₁₄(C₄F₈O)ₙ₁₁₅

(wherein n111, n112, n113, n114, and n115 are each independently an integer of 0 or 1 or greater; X¹¹² is H, F, or Cl; and these repeating units may be present in any order), and one represented by the formula:

—(OC₂F₄—R¹¹⁸)_{f}—

(wherein R¹¹⁸ is a group selected from OC₂F₄, OC₃F₆, and OC₄F₈, and f is an integer of 2 to 100).

The subscripts n111 to n115 are each preferably an integer of 0 to 200. The sum of n111 to n115 is preferably 1 or greater, more preferably 5 to 300, still more preferably 10 to 200, particularly preferably 10 to 100.

R¹¹⁸ is a group selected from OC₂F₄, OC₃F₆, and OC₄F₈ or a combination of two or three groups independently selected from these groups. Non-limiting examples of the combination of two or three groups independently selected from OC₂F₄, OC₃F₆, and OC₄F₈ include —OC₂F₄OC₃F₆—, —OC₂F₄OC₄F₈—, —OC₃F₆OC₂F₄—, —OC₃F₆OC₃F₆—, —OC₃F₆OC₄F₈—, —OC₄F₈OC₄F₈—, —OC₄F₈OC₃F₆—, —OC₄F₈OC₂F₄—, —OC₂F₄OC₂F₄OC₃F₆—, —OC₂F₄OC₂F₄OC₄F₈—, —OC₂F₄OC₃F₆OC₂F₄—, —OC₂F₄OC₃F₆OC₃F₆—, —OC₂F₄OC₄F₈OC₂F₄—, —OC₃F₆OC₂F₄OC₂F₄—, —OC₃F₆OC₂F₄OC₃F₆—, —OC₃F₆OC₃F₆OC₂F₄—, and OC₄F₈OC₂F₄OC₂F₄—. The subscript f is an integer of 2 to 100, preferably an integer of 2 to 50. In each formula, OC₂F₄, OC₃F₆, and OC₄F₈ each may be linear or branched, preferably linear. In this embodiment, the group represented by the formula: —(OC₂F₄—R¹¹⁸)_{f}— is preferably a group represented by the formula: —(OC₂F₄—OC₃F₆)_{f}— or the formula: —(OC₂F₄—OC₄F₈)_{f}—.

The fluoropolyether is preferably at least one selected from the group consisting of one-end methylamine-terminated perfluoropolyether (PFPE) compounds represented by the formulas:

F(CF₂CF₂CF₂O)ₙCF₂CF₂CH₂NH₂

(wherein n is an integer of 1 or greater) and

F₃CF₂CO—(CF₂CF₂CF₂O)ₙCF₂CF₂CH₂NH₂

(wherein n is an integer of 1 or greater); a both-end methylamine-terminated PFPE compound represented by the formula:

H₂NH₂CF₂CF₂CO—(CF₂CF₂CF₂O)ₙCF₂CF₂CH₂NH₂

(wherein n is an integer of 1 or greater); a one-end hydroxymethyl (CH₂OH)-terminated PFPE compound represented by the formula:

F₃CF₂CO—(CF₂CF₂CF₂O)ₙ—CF₂CF₂CH₂OH

(wherein n is an integer of 1 or greater); a both-end hydroxymethyl-terminated PFPE compound represented by the formula:

HOH₂CF₂CF₂CO—(CF₂CF₂CF₂O)ₙ—CF₂CF₂CH₂OH

(wherein n is an integer of 1 or greater); a one-end carboxylic acid (COOH)-terminated PFPE compound represented by the formula:

F₃CF₂CO—(CF₂CF₂CF₂O)ₙ—CF₂CF₂COOH

(wherein n is an integer of 1 or greater); a both-end carboxylic acid (COOH)-terminated PFPE compound represented by the formula:

HOOCF₂CF₂CO—(CF₂CF₂CF₂O)ₙ—CF₂CF₂COOH

(wherein n is an integer of 1 or greater); a one-end CH₂OCH₂CH═CH₂-terminated PFPE compound represented by the formula:

F₃CF₂CO—(CF₂CF₂CF₂O)ₙ—CF₂CF₂CH₂OCH₂CH═CH₂

(wherein n is an integer of 1 or greater); and a both-end CH₂OCH₂CH═CH₂-terminated PFPE compound represented by the formula:

H₂C═CHCH₂OCH₂CF₂CF₂CO—(CF₂CF₂CF₂O)ₙCH₂OCH₂CH═CH₂

(wherein n is an integer of 1 or greater). The fluoropolyether is more preferably at least one selected from the group consisting of the one-end methylamine-terminated perfluoropolyether (PFPE) compounds and the both-end methylamine-terminated PFPE compound represented by the formula.

The fluoropolyether preferably has a weight average molecular weight of 500 to 100000, more preferably 50000 or less, still more preferably 10000 or less, particularly preferably 6000 or less. The weight average molecular weight may be determined by gel permeation chromatography (GPC).

The fluoropolyether is commercially available as, for example, DEMNUM (trade name) (Daikin Industries, Ltd.), Fomblin (Solvay Specialty Polymers Japan K.K.), BARRIERTA (NOK Kluber), and Krytox (DuPont).

The composition of the invention preferably contains the at least one compound selected from the group consisting of a reactive polydialkylsiloxane and a fluoropolyether in an amount of 0.01 to 50 parts by mass relative to 100 parts by mass of the polymer. The compound in an amount within the range indicated above can lead to a coating film having much better weather resistance and stain resistance. The amount is more preferably 0.05 parts by mass or more, still more preferably 0.1 parts by mass or more, while more preferably 20 parts by mass or less, still more preferably 10 parts by mass or less, relative to 100 parts by mass of the polymer.

The composition of the invention preferably further contains a polyisocyanate compound. The polyisocyanate compound is preferably at least one compound selected from the group consisting of a polyisocyanate compound derived from at least one isocyanate selected from the group consisting of a xylylene diisocyanate (XDI) and a bis(isocyanatomethyl)cyclohexanes (hydrogenated XDI (H6XDI)), a blocked isocyanate compound based on hexamethylene diisocyanate (HDI), a polyisocyanate compound derived from hexamethylene diisocyanate (HDI), a polyisocyanate compound derived from isophorone diisocyanate (IPDI), and a water dispersible polyisocyanate compound.

The presence of a polyisocyanate compound (hereinafter, also referred to as polyisocyanate compound

(I)) derived from at least one isocyanate (hereinafter, also referred to as isocyanate (i)) selected from the group consisting of a xylylene diisocyanate (XDI) and a bis(isocyanatomethyl)cyclohexane (hydrogenated XDI (H6XDI)) as the polyisocyanate compound can lead to much better adhesiveness.

Examples of the polyisocyanate compound (I) include an adduct prepared by addition polymerization of the isocyanate (i) and an aliphatic polyhydric alcohol having three or more hydroxy groups, an isocyanurate structure (nurate structure) including the isocyanate (i), and a biuret including the isocyanate (i).

The adduct preferably has, for example, a structure represented by the following formula (1):

### [Chem. 19]

R¹—(OCONH—CH₂—R²—CH₂—NCO)ₖ (1)

wherein R¹ is a C3-C20 aliphatic hydrocarbon group, R² is a phenylene group or a cyclohexylene group, and k is an integer of 3 to 20.

R¹ in the formula (1) is a hydrocarbon group based on the aliphatic polyhydric alcohol having three or more hydroxy groups, preferably a C3-C10 aliphatic hydrocarbon group, more preferably a C3-C6 aliphatic hydrocarbon group.

The phenylene group for R² may be a 1,2-phenylene group (o-phenylene group), a 1,3-phenylene group (m-phenylene group), or a 1,4-phenylene group (p-phenylene group). In particular, a 1,3-phenylene group (m-phenylene group) is preferred. R²s in the formula (1) may be all the same phenylene groups or may include two or more different phenylene groups.

The cyclohexylene group for R² may be a 1,2-cyclohexylene group, a 1,3-cyclohexylene group, or a 1,4-cyclohexylene group. In particular, a 1,3-cyclohexylene group is preferred. R²s in the formula (1) may be all the same cyclohexylene groups or may include two or more different cyclohexylene groups.

The subscript k corresponds to the valence of the aliphatic polyhydric alcohol having three or more hydroxy groups, and is preferably an integer of 3 to 10, more preferably an integer of 3 to 6.

The isocyanurate structure has one or more isocyanurate rings represented by the formula (2):

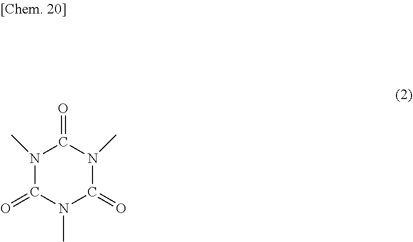

in a molecule.

Examples of the isocyanurate structure include a trimer prepared by trimerization of the isocyanate, a pentamer prepared by pentamerization of the isocyanate, and a heptamer prepared by heptamerization of the isocyanate.

In particular, the isocyanurate structure is preferably a trimer represented by the formula (3):

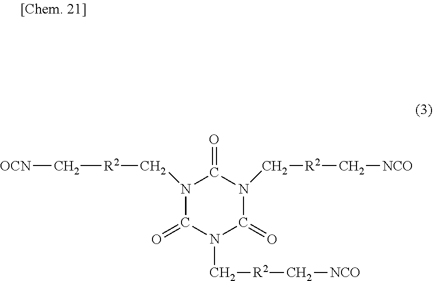

(wherein R² is the same as R² in the formula (1)). Specifically, the isocyanurate structure is preferably a trimer of at least one isocyanate selected from the group consisting of a xylylene diisocyanate and a bis(isocyanatomethyl)cyclohexane.

The biuret is a compound having a structure represented by the formula (4):

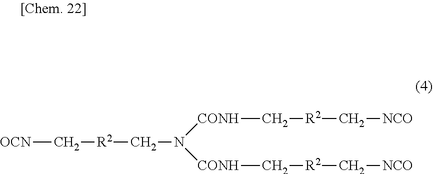

(wherein R² is the same as R² in the formula (1)). The biuret can be prepared by trimerization of the isocyanate under the conditions different from those for obtaining the isocyanurate structure.

In particular, the polyisocyanate compound (I) is preferably the adduct which is specifically prepared by addition polymerization of an aliphatic polyhydric alcohol having three or more hydroxy groups and at least one isocyanate selected from the group consisting of a xylylene diisocyanate and a bis(isocyanatomethyl)cyclohexane.

When the polyisocyanate compound (I) is an adduct of the isocyanate (i) and an aliphatic polyhydric alcohol having three or more hydroxy groups, the aliphatic polyhydric alcohol having three or more hydroxy groups is specifically exemplified by trihydric alcohols such as glycerol, trimethylolpropane (TMP), 1,2,6-hexanetriol, trimethylolethane, 2,4-dihydroxy-3-hydroxymethylpentane, 1,1,1-tris(bishydroxymethyl)propane, and 2,2-bis(hydroxymethyl)butanol-3; tetrahydric alcohols such as pentaerythritol and diglycerol; pentahydric alcohols (pentit) such as arabite, ribitol, and xylitol; and hexahydric alcohols (hexit) such as sorbit, mannit, galactitol, and allodulcit. In particular, trimethylolpropane and pentaerythritol are preferred.

The xylylene diisocyanate (XDI) that may be used as a constituent of the adduct can be exemplified by 1,3-xylylene diisocyanate (m-xylylene diisocyanate), 1,2-xylylene diisocyanate (o-xylylene diisocyanate), and 1,4-xylylene diisocyanate (p-xylylene diisocyanate). In particular, 1,3-xylylene diisocyanate (m-xylylene diisocyanate) is preferred.

The bis(isocyanatomethyl)cyclohexane (hydrogenated XDI (H6XDI)) that may be used as a constituent of the adduct can be exemplified by 1,3-bis(isocyanatomethyl)cyclohexane, 1,2-bis(isocyanatomethyl)cyclohexane, and 1,4-bis(isocyanatomethyl)cyclohexane. In particular, 1,3-bis(isocyanatomethyl)cyclohexane is preferred.

The adduct can be prepared by addition polymerization of the aliphatic polyhydric alcohol having three or more hydroxy groups and at least one isocyanate selected from the group consisting of a xylylene diisocyanate and a bis(isocyanatomethyl)cyclohexane.

A specific example of the adduct is a compound represented by the formula (5):

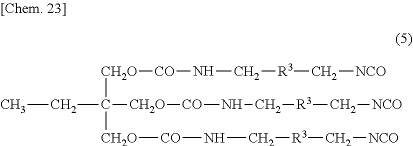

(wherein R³ is a phenylene group or a cyclohexylene group), specifically, a polyisocyanate compound prepared by addition polymerization of trimethylolpropane (TMP) and at least one isocyanate selected from the group consisting of a xylylene diisocyanate and a bis(isocyanatomethyl)cyclohexane.

The phenylene group and cyclohexylene group for R³ in the formula (5) are the same as those for R² in the formula (1).

The polyisocyanate compound represented by the formula (5) is commercially available as, for example, Takenate D110N (Mitsui Chemicals, Inc., XDI/TMP adduct, NCO content: 11.8%) and Takenate D120N (Mitsui Chemicals, Inc., H6XDI/TMP adduct, NCO content: 11.0%).

Specific examples of the polyisocyanate compound (I) in the form of an isocyanurate structure include Takenate D121N (Mitsui Chemicals, Inc., H6XDI nurate, NCO content: 14.0%) and Takenate D127N (Mitsui Chemicals, Inc., H6XDI nurate, trimer of H6XDI, NCO content: 13.5%).

The presence of a blocked isocyanate based on hexamethylene diisocyanate (HDI) (hereinafter, also referred to simply as blocked isocyanate) as the polyisocyanate compound can lead to a composition having a sufficient pot life (working life).

The blocked isocyanate is preferably prepared by reacting a polyisocyanate compound derived from hexamethylene diisocyanate (hereinafter, also referred to as polyisocyanate compound (II)) with a blocking agent. Examples of the polyisocyanate compound (II) include an adduct prepared by addition polymerization of hexamethylene diisocyanate and an aliphatic polyhydric alcohol having three or more hydroxy groups, an isocyanurate structure (nurate structure) including hexamethylene diisocyanate, and a biuret including hexamethylene diisocyanate.

The adduct preferably has, for example, a structure represented by the formula (6):

### [Chem. 24]

R⁴—(OCONH—(CH₂)₆—NCO)ₖ (6)

wherein R⁴ is a C3-C20 aliphatic hydrocarbon group and k is an integer of 3 to 20.

R⁴ in the formula (6) is a hydrocarbon group based on the aliphatic polyhydric alcohol having three or more hydroxy groups, preferably a C3-C10 aliphatic hydrocarbon group, more preferably a C3-C6 aliphatic hydrocarbon group.

The subscript k corresponds to the valence of the aliphatic polyhydric alcohol having three or more hydroxy groups, and is preferably an integer of 3 to 10, more preferably an integer of 3 to 6.

The isocyanurate structure has one or more isocyanurate rings represented by the formula (2):

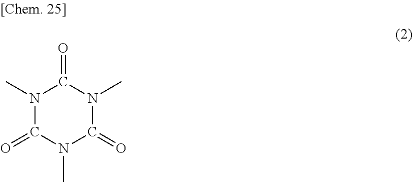

in a molecule.

Examples of the isocyanurate structure include a trimer prepared by trimerization of the isocyanate, a pentamer prepared by pentamerization of the isocyanate, and a heptamer prepared by heptamerization of the isocyanate.

In particular, the trimer represented by the formula (7):

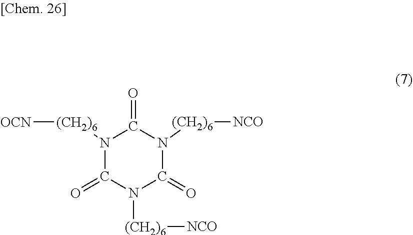

is preferred.

The biuret is a compound having a structure represented by the formula (8):

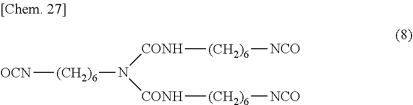

and can be prepared by trimerization of hexamethylene diisocyanate under the conditions different from those for obtaining the isocyanurate structure.

The blocking agent may preferably be a compound containing an active hydrogen. The compound containing an active hydrogen may preferably be at least one selected from the group consisting of alcohols, oximes, lactams, active methylene compounds, and pyrazole compounds.

Thus, the blocked isocyanate is preferably prepared by reacting a polyisocyanate compound derived from hexamethylene diisocyanate with a blocking agent, and the blocking agent is preferably at least one selected from the group consisting of alcohols, oximes, lactams, active methylene compounds, and pyrazole compounds.

When the polyisocyanate compound (II) for obtaining the blocked isocyanate is an adduct of hexamethylene diisocyanate and an aliphatic polyhydric alcohol having three or more hydroxy groups, the aliphatic polyhydric alcohol having three or more hydroxy groups is specifically exemplified by trihydric alcohols such as glycerol, trimethylolpropane (TMP), 1,2,6-hexanetriol, trimethylolethane, 2,4-dihydroxy-3-hydroxymethylpentane, 1,1,1-tris(bishydroxymethyl)propane, and 2,2-bis(hydroxymethyl)butanol-3; tetrahydric alcohols such as pentaerythritol and diglycerol; pentahydric alcohols (pentit) such as arabite, ribitol, and xylitol; and hexahydric alcohols (hexit) such as sorbit, mannit, galactitol, and allodulcit. In particular, trimethylolpropane and pentaerythritol are preferred.

The adduct can be prepared by addition polymerization of hexamethylene diisocyanate and the aliphatic polyhydric alcohol having three or more hydroxy groups.

Specific examples of the compound containing an active hydrogen to be reacted with the polyisocyanate compound (II) include alcohols such as methanol, ethanol, n-propanol, isopropanol, and methoxy propanol; oximes such as acetone oxime, 2-butanone oxime, and cyclohexanone oxime; lactams such as ϵ-caprolactam; active methylene compounds such as methyl acetoacetate and ethyl malonate; and pyrazole compounds such as 3-methylpyrazole, 3,5-dimethylpyrazole, and 3,5-diethylpyrazole. One or more of these may be used.

In particular, active methylene compounds and oximes are preferred, with active methylene compounds being more preferred.

The blocked isocyanate is commercially available as, for example, Duranate K6000 (Asahi Kasei Chemicals Corporation, HDI-derived blocked isocyanate with an active methylene compound), Duranate TPA-B80E (Asahi Kasei Chemicals Corporation), Duranate MF-B60X (Asahi Kasei Chemicals Corporation), Duranate 17B-60PX (Asahi Kasei Chemicals Corporation), Coronate 2507 (Nippon Polyurethane Industry Co., Ltd.), Coronate 2513 (Nippon Polyurethane Industry Co., Ltd.), Coronate 2515 (Nippon Polyurethane Industry Co., Ltd.), Sumidur BL-3175 (Sumika Bayer Urethane Co., Ltd.), Luxate HC1170 (Olin Chemicals), and Luxate HC2170 (Olin Chemicals).

The polyisocyanate compound may be a polyisocyanate compound derived from hexamethylene diisocyanate (HDI) (hereinafter, also referred to as polyisocyanate compound (III)). Examples of the polyisocyanate compound (III) include the compounds listed for the polyisocyanate compound (II).

Specific examples of the polyisocyanate compound (III) include Coronate HX (Nippon Polyurethane Industry Co., Ltd., isocyanurate structure of hexamethylene diisocyanate, NCO content: 21.1%), Sumidur N3300 (Sumika Bayer Urethane Co., Ltd., isocyanurate structure of hexamethylene diisocyanate), Takenate D170N (Mitsui Chemicals, Inc., isocyanurate structure of hexamethylene diisocyanate), and Sumidur N3800 (Sumika Bayer Urethane Co., Ltd., isocyanurate structure prepolymer type of hexamethylene diisocyanate), D-370N (Mitsui Chemicals, Inc., NCO content: 25.0%), AE-700 (Asahi Kasei Corporation., NCO content: 11.9%), and D-201 (Mitsui Chemicals, Inc., NCO content: 15.8%).

The polyisocyanate compound may be a polyisocyanate compound derived from isophorone diisocyanate (IPDI) (hereinafter, also referred to as polyisocyanate compound (IV)).

Examples of the polyisocyanate compound (IV) include an adduct prepared by addition polymerization of isophorone diisocyanate and an aliphatic polyhydric alcohol having three or more hydroxy groups, an isocyanurate structure (nurate structure) including isophorone diisocyanate, and a biuret including isophorone diisocyanate.

The adduct preferably has, for example, a structure represented by the formula (9):

### [Chem. 28]

R⁵—(OCONH—R ⁶—NCO)ₖ (9)

wherein R⁵ is a C3-C20 aliphatic hydrocarbon group, R⁶ is a group represented by the formula (10):

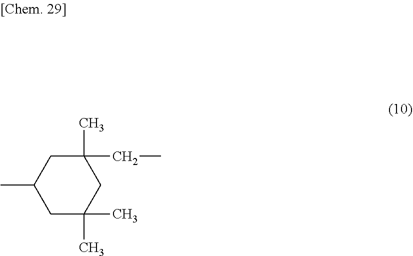

and k is an integer of 3 to 20.

R⁵ in the formula (9) is a hydrocarbon group based on the aliphatic polyhydric alcohol having three or more hydroxy groups, preferably a C3-C10 aliphatic hydrocarbon group, more preferably a C3-C6 aliphatic hydrocarbon group.

The subscript k corresponds to the valence of the aliphatic polyhydric alcohol having three or more hydroxy groups, and is preferably an integer of 3 to 10, more preferably an integer of 3 to 6.

The isocyanurate structure has one or more isocyanurate rings represented by the formula (2):

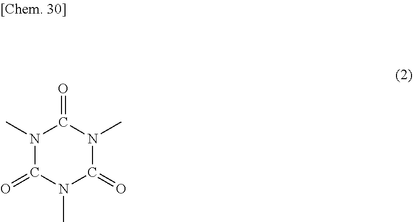

in a molecule.

Examples of the isocyanurate structure include a trimer prepared by trimerization of isophorone diisocyanate, a pentamer prepared by pentamerization of isophorone diisocyanate, and a heptamer prepared by heptamerization of isophorone diisocyanate.

In particular, a trimer represented by the formula

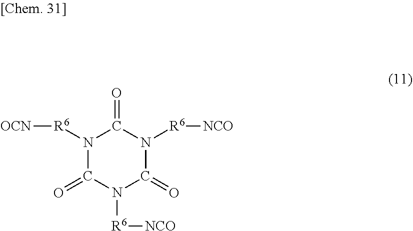

(wherein R⁶ is the same as R⁶ in the formula (9)) is preferred. Specifically, the isocyanurate structure is preferably a trimer of isophorone diisocyanate.

The biuret is a compound having a structure represented by the formula (12):

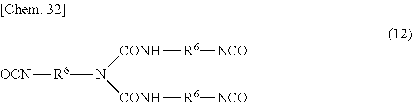

(wherein R⁶ is the same as R⁶ in the formula (9)). The biuret can be prepared by trimerization of the isophorone diisocyanate under the conditions different from those for obtaining the isocyanurate structure.

In particular, the polyisocyanate compound (IV) is preferably at least one selected from the group consisting of the adduct and the isocyanurate structure. Specifically, the polyisocyanate compound (IV) is preferably at least one selected from the group consisting of an adduct prepared by addition polymerization of isophorone diisocyanate and an aliphatic polyhydric alcohol having three or more hydroxy groups and an isocyanurate structure including isophorone diisocyanate.

When the polyisocyanate compound (IV) is an adduct of isophorone diisocyanate and an aliphatic polyhydric alcohol having three or more hydroxy groups, the aliphatic polyhydric alcohol having three or more hydroxy groups is specifically exemplified by trihydric alcohols such as glycerol, trimethylolpropane (TMP), 1,2,6-hexanetriol, trimethylolethane, 2,4-dihydroxy-3-hydroxymethylpentane, 1,1,1-tris(bishydroxymethyl)propane, and 2,2-bis(hydroxymethyl)butanol-3; tetrahydric alcohols such as pentaerythritol and diglycerol; pentahydric alcohols (pentit) such as arabite, ribitol, and xylitol; and hexahydric alcohols (hexit) such as sorbit, mannit, galactitol, and allodulcit. In particular, trimethylolpropane and pentaerythritol are preferred.

The adduct to be suitably used in the invention can be prepared by addition polymerization of isophorone diisocyanate and the aliphatic polyhydric alcohol having three or more hydroxy groups.

A specific example of the adduct to be suitably used in the invention is a compound represented by the formula (13):

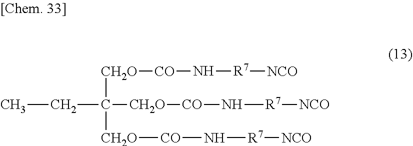

(wherein R⁷ is a group represented by the formula (10):

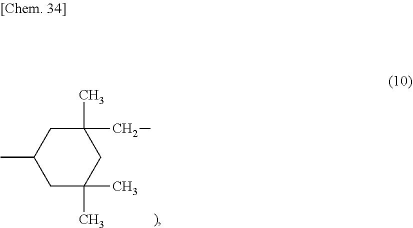

that is, a polyisocyanate compound prepared by addition polymerization of isophorone diisocyanate and trimethylolpropane (TMP).

The polyisocyanate compound represented by the formula (13) (TMP adduct of isophorone diisocyanate) is commercially available as, for example, Takenate D140N (Mitsui Chemicals, Inc., NCO content: 11%).

The isocyanurate structure including isophorone diisocyanate is commercially available as, for example, Desmodur 24470 (Sumika Bayer Urethane Co., Ltd., NCO content: 11%).

The polyisocyanate compound may be a water dispersible polyisocyanate compound. The water dispersible polyisocyanate compound refers to a polyisocyanate compound capable of forming an aqueous dispersion when it is stirred in an aqueous medium. Examples of the water dispersible polyisocyanate compound include (1) a mixture of a hydrophobic polyisocyanate and a hydrophilic group-containing polyisocyanate, (2) a mixture of a hydrophobic polyisocyanate and a dispersant not containing an isocyanate group but containing a hydrophilic group, and (3) a hydrophilic group-containing polyisocyanate itself. The hydrophilic group in the invention refers to an anionic group, a cationic group, or a nonionic group. The water dispersible polyisocyanate compound is particularly preferably a hydrophilic group-containing polyisocyanate.

The hydrophobic polyisocyanate contains no hydrophilic group, and examples thereof include aliphatic diisocyanates such as 1,4-tetramethylene diisocyanate, ethyl (2,6-diisocyanato)hexanoate, 1,6-hexamethylene diisocyanate, 1,12-dodecamethylene diisocyanate, and 2,2,4- or 2,4,4-trimethylhexamethylene diisocyanate; aliphatic triisocyanates such as 1,3,6-hexamethylene triisocyanate, 1,8-diisocyanato-4-isocyanatomethyloctane, and 2-isocyanatoethyl (2,6-diisocyanato)hexanoate; alicyclic diisocyanates such as 1,3-bis(isocyanatomethyl)cyclohexane, 1,4-bis(isocyanatomethyl)cyclohexane, 1,3-diisocyanatocyclohexane, 1,4-diisocyanatocyclohexane, 3,5,5-trimethyl (3-isocyanatomethyl)cyclohexyl isocyanate, dicyclohexylmethane-4,4′-diisocyanate, 2,5-diisocyanatomethyl norbornane, and 2,6-diisocyanatomethyl norbornane; alicyclic triisocyanates such as 2,5-diisocyanatomethyl-2-isocynatopropyl norbornane and 2,6-diisocyanatomethyl-2-isocynatopropyl norbornane; aralkylene diisocyanates such as m-xylylene diisocyanate and α,α,α′α′-tetramethyl-m-xylylene diisocyanate; aromatic diisocyanates such as m- or p-phenylene diisocyanate, tolylene-2,4-diisocyanate, tolylene-2,6-diisocyanate, diphenylmethane-4,4′-diisocyanate, naphthalene-1,5-diisocyanate, diphenyl-4,4′-diisocyanate, 4,4′-diisocyanato-3,3′-dimethyl diphenyl, 3-methyl-diphenylmethane-4,4′-diisocyanate, and diphenyl ether-4,4′-diisocyanate; aromatic triisocyanates such as triphenylmethane triisocyanate and tris(isocyanatophenyl)thiophosphate; polyisocyanates each having a uretdione structure that is prepared by cyclodimerization of the isocyanate groups of any of the above-listed diisocyanates and triisocyanates; polyisocyanates each having an isocyanurate structure that is prepared by cyclotrimerization of the isocyanate groups of any of the above-listed diisocyanates and triisocyanates; polyisocyanates each having a biuret structure that is prepared by reacting any of the above-listed diisocyanates and triisocyanates with water; polyisocyanates each having an oxadiazinetrione structure that is prepared by reacting any of the above-listed diisocyanates and triisocyanates with carbon dioxide; and polyisocyanates each having an allophanate structure. Preferred among these are polyisocyanates each having an isocyanurate structure because they can provide densely crosslinked coating films and cured coating films having better alcohol resistance.

Examples of the hydrophilic group-containing polyisocyanate include polyethers, polyesters, polyurethanes, vinyl polymers, alkyd resins, fluororesins, and silicon resins, each containing a hydrophilic group and an isocyanate group. Preferred among these are hydrophilic group- and isocyanate group-containing polyethers and hydrophilic group- and isocyanate group-containing vinyl polymers because they are well dispersed in water. More preferred are hydrophilic group- and isocyanate group-containing polyethers. These hydrophilic group-containing polyisocyanates may be used alone or in combination of two or more thereof.

The water dispersible polyisocyanate compounds are commercially available as, for example, Bayhydur XP 2700 (Sumika Bayer Urethane) or Bayhydur 3100 (Sumika Bayer Urethane).

In particular, the polyisocyanate compound is more preferably Takenate D120N (Mitsui Chemicals, Inc., NCO content: 11%) or Sumidur N3300 (Sumika Bayer Urethane Co., Ltd., isocyanurate structure of hexamethylene diisocyanate).

In order to achieve high weather resistance, the composition preferably has an equivalent ratio (NCO/OH) between the isocyanate groups (NCO) of the polyisocyanate compound and the hydroxy groups (OH) of the polymer of preferably 0.7 or greater, more preferably 0.8 or greater, preferably 1.5 or smaller, more preferably 1.4 or smaller.

The composition of the invention preferably further contains a solvent. The solvent is preferably water or an organic solvent. Examples of the organic solvent include esters such as ethyl acetate, n-butyl acetate, tert-butyl acetate, isopropyl acetate, isobutyl acetate, cellosolve acetate, and propylene glycol methyl ether acetate; ketones such as acetone, methyl ethyl ketone, methyl isobutyl ketone, and cyclohexanone; cyclic ethers such as tetrahydrofuran and dioxane; amides such as N,N-dimethyl formamide and N,N-dimethyl acetamide; aromatic hydrocarbons such as toluene and xylene; alcohols such as propylene glycol methyl ether; hydrocarbons such as hexane and heptane; and solvent mixtures thereof. Examples of the solvent also include the third-class organic solvents mentioned in the Industrial Safety and Health Act and solvents equivalent thereto, which are called weak solvents. In the case of preparing a solution of the polymer in an organic solvent, the concentration of the polymer is 5 to 95% by mass, preferably 10 to 80% by mass.

The composition preferably further contains a different resin other than the polymer. Examples of the different resin include organic resin such as polystyrene, (meth)acrylic resin, polyester resin, alkyd resin, melamine-formaldehyde resin, polyisocyanate resin, epoxy resin, vinyl chloride-containing resin (e.g., vinyl chloride-vinyl acetate copolymers), ketone resin, petroleum resin, or a chlorinated product of a polyolefin such as polyethylene or polypropylene; inorganic resin such as silica gel and silicic acid; and various fluororesins other than the polymer (e.g., homopolymers of tetrafluoroethylene and of chlorotrifluoroethylene, and a copolymer thereof with another monomer). The amount of the different resin is 900 parts by mass or less, preferably 500 parts by mass or less, relative to 100 parts by mass of the polymer. The lower limit thereof is an amount required to achieve the target properties, and depends on the type of the resin. For (meth)acrylic resin, the lower limit is usually 5 parts by mass or more, preferably 10 parts by mass or more.

The composition preferably contains a (meth)acrylic resin especially having excellent miscibility among these resins, which can lead to a coating film having good gloss, high hardness, and good finish appearance.

Examples of the (meth)acrylic resin include (meth)acrylic polymers conventionally used for coating materials. Particularly preferred are (i) a homopolymer anc copolymer of a C1-C10 alkyl ester of (meth)acrylic acid and (ii) a (meth)acrylic acid ester copolymer having a curable functional group in a side chain and/or at an end of the main chain.

Examples of the (meth)acrylic polymer (i) include a homopolymer and copolymer of a C1-C10 alkyl ester of (meth)acrylic acid such as n-butyl(meth)acrylate, isobutyl(meth)acrylate, and 2-ethylhexyl (meth)acrylate, and a copolymer thereof with an ethylenically unsaturated monomer copolymerizable therewith.

Examples of the copolymerizable ethylenically unsaturated monomer include aromatic vinyl monomers such as an aromatic group-containing (meth)acrylate, a (meth)acrylate having a fluorine atom or a chlorine atom at the a position, a fluoroalkyl(meth)acrylate obtained by substituting an alkyl group with a fluorine atom, a vinyl ether, a vinyl ester, and styrene; olefins such as ethylene, propylene, isobutylene, vinyl chloride, and vinylidene chloride; fumaric acid diesters; maleic acid diesters; and (meth)acrylonitrile.

Examples of the (meth)acrylic polymers (ii) include copolymers of a monomer that produces the (meth)acrylic polymer (i) described above and a curable functional group-containing monomer. Examples of the curable functional group-containing monomer include monomers having any of a hydroxy group, a carboxy group, an epoxy group, and an amino group. Specific examples of the (meth)acrylic polymers (ii) include, but are not limited to, copolymers of a monomer having a curable functional group such as hydroxyethyl(meth) acrylate, 2-hydroxypropyl(meth)acrylate, 2-hydroxyethyl vinyl ether, (meth)acrylic acid, glycidyl(meth)acrylate, 2-aminoethyl(meth)acrylate, or 2-aminopropyl(meth)acrylate and the C1-C10 alkyl ester of (meth)acrylic acid and copolymers of any of these monomers and the copolymerizable ethylenically unsaturated monomer.

The (meth)acrylic polymer preferably has a number average molecular weight determined by GPC of 1000 to 200000, more preferably 2000 to 100000. The higher the number average molecular weight is, the lower the solvent solubility tends to be. The lower the number average molecular weight is, the more inappropriate the weather resistance tends to be.

The composition may further contain an additive. Examples of the additive include a curing accelerator, a pigment, a dispersant, a fluidity improver, a leveling agent, an antifoam, an anti-gelling agent, an ultraviolet absorber, an antioxidant, a hydrophilic agent, a flatting agent, an adhesiveness promoter, and a flame retarder.

Examples of the pigment include titanium dioxide. The titanium dioxide may be in any form, either rutile or anatase. In order to achieve good weather resistance, the rutile form is preferred. The titanium dioxide may be in the form of fine particles having a surface subjected to inorganic treatment or organic treatment, or to both inorganic and organic treatments. Examples of the inorganically treated titanium dioxide include titanium dioxide fine particles having a surface coated with alumina (Al₂O₃), silica (SiO₂), or zirconia (ZrO₂). Examples of the organically treated titanium dioxide include those surface-treated with a silane-coupling agent, those surface-treated with an organosiloxane, those surface-treated with an organic polyol, and those surface-treated with an alkyl amine. The titanium dioxide preferably has a basic value higher than the acid value thereof determined by titration.

Examples of commercially available products of the titanium dioxide include D-918 (Sakai Chemical Industry Co., Ltd.), R-960, R-706, and R-931 (DuPont), and PFC-105 (Ishihara Sangyo Kaisha, Ltd.).

The amount of the titanium dioxide is preferably 1 to 500 parts by mass relative to 100 parts by mass of the polymer. Less than 1 part by mass of the titanium dioxide may fail to block ultraviolet rays. More than 500 parts by mass thereof may cause yellowing and deterioration due to ultraviolet rays. The amount of the titanium dioxide is more preferably 5 parts by mass or more, still more preferably 10 parts by mass or more, while more preferably 300 parts by mass or less, still more preferably 200 parts by mass or less.

The pigment may also be carbon black. The carbon black may be any one, such as any of those commonly known. In order to achieve an effect of blocking ultraviolet rays, the carbon black preferably has an average particle size of 10 to 150 nm, more preferably 20 to 100 nm. The average particle size is a value determined by electron microscopic observation.

The carbon black may agglomerate in the composition. In order to achieve an effect of blocking ultraviolet rays, the average particle size thereof in this case is preferably 50 to 1000 nm, more preferably 100 to 700 nm, still more preferably 100 to 500 nm. The average particle size is a value determined using a laser diffraction scattering particle size distribution analyzer.

The amount of the carbon black is preferably 0.5 to 80 parts by mass relative to 100 parts by mass of the polymer. The carbon black in an amount within the above range can well disperse in the composition. The amount of the carbon black is more preferably 3 parts by mass or more, still more preferably 10 parts by mass or more, while more preferably 60 parts by mass or less, still more preferably 50 parts by mass or less, relative to 100 parts by mass of the polymer.

Examples of commercially available products of the carbon black include MA-100 (Mitsubishi Chemical Corp.) and Raven-420 (Columbian Carbon Co.).

The composition containing the pigment preferably further contains a dispersant or fluidity improver mentioned below.

An example of the dispersant is a compound containing an acid radical (other than those having an unsaturated group). Examples of the acid radical include a phosphate group, a carboxylate group, and a sulfonate group. In order to prevent agglomeration of the pigment for a longer time and to achieve excellent storage stability of the composition, the acid radical is preferably at least one selected from the group consisting of a phosphate group and a carboxylate group, more preferably a phosphate group. The dispersant also contains a compound free from an unsaturated group. The compound free from an unsaturated group is less likely to be degenerated by exposure to ultraviolet rays.

The dispersant preferably has a weight average molecular weight of 300 to 1000000. The dispersant having a weight average molecular weight of less than 300 may have an adsorbed resin layer with insufficient steric stabilization, failing to prevent agglomeration of the titanium dioxide. The dispersant having a weight average molecular weight exceeding 1000000 may cause mottle and reduced weather resistance. The weight average molecular weight is more preferably 1000 or more and 100000 or less. The weight average molecular weight may be determined by gel permeation chromatography (GPC) (polystyrene equivalent).

In order to achieve effective adsorption to the titanium dioxide surface, the dispersant preferably has an acid value of 3 to 2000 mgKOH/g. The acid value is more preferably 5 mgKOH/g or higher, still more preferably 10 mgKOH/g or higher, while more preferably 1000 mgKOH/g or lower, still more preferably 500 mgKOH/g or lower. The acid value may be determined by acid-base titration using a basic substance.

The dispersant may further contain a base. The base may be an amino group, for example.

In order to achieve good long-term storage stability of the dispersant, the dispersant preferably has a basic value of 15 mgKOH/g or lower, more preferably 5 mgKOH/g or lower. The dispersant having an acid value of 15 mgKOH/g or lower still more preferably has a basic value of lower than 5 mgKOH/g.

The dispersant is still more preferably substantially free from a base. Considering contamination, reaction residues, measurement errors, and other relating factors, the phrase “substantially free from a base” herein means that the measured basic value is 0.5 mgKOH/g or lower. The basic value may be determined by acid-base titration using an acidic substance.

The dispersant may be any of commercially available products. Examples thereof include DISPARLON 2150, DISPARLON DA-325, DA-375, and DA-1200 (trade name, Kusumoto Chemicals, Ltd.), FLOWLEN G-700 and G-900 (trade name, Kyoeisha Chemical Co., Ltd.), SOLSPERSE 26000, 32000, 36000, 36600, 41000, and 55000 (trade name, Lubrizol Japan Ltd.), and DISPERBYK-102, 106, 110, 111, 140, 142, 145, 170, 171, 174, and 180 (trade name, BYK Japan KK). In order to achieve good long-term storage stability, preferred are DISPARLON DA-375, FLOWLEN G-700, and SOLSPERSE 36000, with DISPARLON DA-375 being more preferred.

The dispersant is preferably used in combination with the titanium dioxide. The amount of the dispersant is preferably 0.1 to 100 parts by mass relative to 100 parts by mass of the titanium dioxide. Less than 0.1 parts by mass of the dispersant may fail to achieve an effect of preventing precipitation of the pigment. More than 100 parts by mass thereof tends to cause mottle and reduced weather resistance. The amount of the dispersant is more preferably 0.5 parts by mass or more, still more preferably 1.5 parts by mass or more, while more preferably 50 parts by mass or less, still more preferably 20 parts by mass or less.

The fluidity improver may be an associative acrylic polymer having an acid radical and a base. The associative acrylic polymer herein means a polymer in which polar groups contained in the acrylic polymer chains form a structure by, for example, partial adsorption owing to hydrogen bonds or electric interactions in the polymer chains or between the polymer chains to achieve an effect of increasing the viscosity of the liquid.

Examples of the associative acrylic polymer include copolymers containing, as a main monomer component, a (meth)acrylate such as methyl(meth)acrylate, ethyl(meth)acrylate, n-butyl(meth)acrylate, isobutyl(meth)acrylate, t-butyl(meth)acrylate, n-octyl(meth)acrylate, isooctyl(meth)acrylate, 2-ethylhexyl(meth)acrylate, isononyl(meth)acrylate, and cyclohexyl(meth)acrylate. The term “(meth)acrylate” herein includes both acrylate and methacrylate.

The acid radical is preferably a carboxylate group, a phosphate group, or a sulfonate group. In order to prevent agglomeration of the pigment for a long time and to maintain the storage stability of the composition, a carboxylate group is particularly preferred. The base may be an amino group.

The fluidity improver may be a reaction product of a carboxylic acid and a nitrogen-containing compound such as a hydroxylamine or hydroxyimine. The carboxylic acid and the nitrogen-containing compound are most preferably reacted in a ratio of 1:1. Examples of the carboxylic acid include dicarboxylic acids and acid anhydrides. Examples of the hydroxylamine include primary, secondary, or tertiary alkanol amines such as monoethanol amine, propanol amine, diethanol amine, triethanol amine, and n-butyl diethanol amine, and mixtures thereof. Examples of the hydroxyimine include those having an oxazoline structure such as, specifically, Alkaterge T (trade name, Angus Chemical Co.).

The fluidity improver preferably has a weight average molecular weight of 1000 to 1000000. A fluidity improver having a weight average molecular weight of less than 1000 may insufficiently form an associative structure and fail to prevent precipitation of the titanium dioxide. A fluidity improver having a weight average molecular weight exceeding 1000000 may cause an excessive increase in the viscosity of the liquid, impairing the coating easiness. The weight average molecular weight is more preferably 5000 or more and 100000 or less. The weight average molecular weight may be determined by gel permeation chromatography (GPC) (polystyrene equivalent).

The fluidity improver may be a commercially available product. An example thereof is SOLTHIX 250 (trade name, Lubrizol Japan Ltd.).

The amount of the fluidity improver is preferably 0.05 to 20 by mass in the composition. Less than 0.05% by mass of the fluidity improver may fail to prevent precipitation of the titanium dioxide. More than 20% by mass thereof may cause separation or mottle. The amount of the fluidity improver is more preferably 0.1% by mass or more, still more preferably 0.3% by mass or more, while more preferably 10% by mass or less, still more preferably 5% by mass or less.

The flame retarder is preferably an agent generating incombustible gas in an early stage of combustion to dilute combustible gas and/or to block oxygen, thereby achieving the incombustibility.

The flame retarder is preferably at least one selected from the group consisting of compounds containing an element from Group 5B of the Periodic Table and compounds containing a halogen element from Group 7B of the Periodic Table.

Examples of the compounds containing a halogen compound from Group 7B of the Periodic Table include aliphatic, alicyclic, or aromatic organohalogen compounds, such as bromine-based compounds, including tetrabromobisphenol A (TBA), decabromodiphenyl ether (DBDPE), octabromodiphenyl ether (OBDPE), TBA epoxy/phenoxy oligomers, and brominated crosslinked polystyrene, and chlorine-based compounds, including chlorinated paraffin and perchlorocyclopentadecane.

Examples of the compounds containing an element from Group 5B of the Periodic Table include phosphorus compounds such as phosphoric acid esters and polyphosphoric acid salts. Also preferred are antimony compounds used in combination with a halogen compound, such as antimony trioxide and antimony pentoxide. Aluminum hydroxide, magnesium hydroxide, and molybdenum trioxide may also be used.

At least one of these flame retarders may be selected and used in any amount in accordance with the type of the polymer, and the flame retarder is not limited thereto.

The flame retarder is specifically more preferably a phosphorus- and nitrogen-containing composition (A) or a mixture (B) of a bromine-containing compound and an antimony-containing compound. Combination of the polymer with such a flame retarder leads to high incombustibility.

The phosphorus- and nitrogen-containing composition (A) is preferably a mixture of a piperazine pyrophosphate and melamine cyanurate. Examples of the piperazine pyrophosphate include those disclosed in JP S48-088791 A and in U.S. Pat. No. 4,599,375 B. Ane example of the melamine cyanurate is powder of a reaction product of melamine and cyanuric acid. The reaction product of melamine and cyanuric acid has many nitrogen atoms in the structure, and generates nitrogen gas when exposed to a high temperature of about 350° C. or higher, exhibiting an action of inhibiting combustion.

The phosphorus- and nitrogen-containing composition (A) preferably satisfies that the mass ratio of the melamine cyanurate to the piperazine pyrophosphate is 0.014 to 3.000. The melamine cyanurate in a ratio within the above range can improve the incombustibility and lead to good blocking performance of the coating film. The mass ratio of the melamine cyanurate to the piperazine pyrophosphate is more preferably 0.04 or higher, still more preferably 0.1 or higher, while more preferably 1.4 or lower, still more preferably 0.5 or lower, in the mixture.

Examples of commercially available products to be used as the phosphorus- and nitrogen-containing composition (A) include SCFR-200 (Sakai Chemical Industry Co., Ltd.) and SCFR-110 (Sakai Chemical Industry Co., Ltd.).

The bromine-containing compound is preferably an aromatic compound having a bromine content of 65% or higher, a melting point of 200° C. or higher, and a 5% decomposition temperature of 340° C. or higher.

Specifically, the bromine-containing compound is preferably at least one selected from the group consisting of decabromodiphenyl oxide, 1,2-bis(2,3,4,5,6-pentabromophenyl)ethane, tris(tribromophenoxy)triazine, ethylene bistetrabromophthalimide, polybromophenylindan, brominated phenylene oxide, and polypentabromobenzyl acrylate.

In particular, 1,2-bis(2,3,4,5,6-pentabromophenyl)ethane represented by the following formula (a) is more preferred because it has a high melting point and does not melt or bleed out even when the coating film is heat-cured.

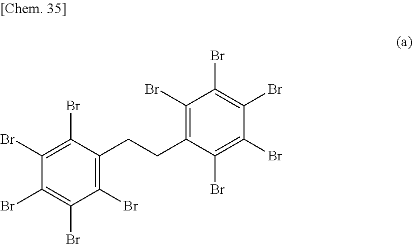 [SMILES: Brc1c(Br)c(Br)c(CCc2c(Br)c(Br)c(Br)c(Br)c2Br)c(Br)c1Br]

The bromine-containing compound may be a commercially available product, such as SAYTEX 8010 (Albemarle Corp.).

Examples of the antimony-containing compound include antimony oxides such as antimony trioxide and antimony pentoxide. In particular, antimony trioxide is preferred because it is available at low cost.

The amount of the flame retarder is preferably 1 to 45 parts by mass relative to 100 parts by mass of the polymer. The flame retarder in an amount within the above range is expected to have good dispersibility in the composition and to improve the incombustibility of a coating film obtainable from the composition. Less than 1 part by mass of the flame retarder may fail to improve the incombustibility. More than 45 parts by mass thereof may cause difficulty in maintaining the physical properties of the composition and the coating film. The amount of the flame retarder is more preferably 30 parts by mass or less, still more preferably 20 parts by mass or less, particularly preferably 15 parts by mass or less, relative to 100 parts by mass of the polymer. The amount thereof is more preferably 3 parts by mass or more, still more preferably 5 parts by mass or more.

For the flame retarder which is the phosphorus- and nitrogen-containing composition (A), the amount thereof is preferably 8 to 19 parts by mass relative to 100 parts by mass of the polymer. The amount of the phosphorus- and nitrogen-containing composition (A) is more preferably 9 parts by mass or more, still more preferably 10 parts by mass or more, while more preferably 17 parts by mass or less, still more preferably 15 parts by mass or less, relative to 100 parts by mass of the polymer.

For the flame retarder which is the mixture (B) of a bromine-containing compound and an antimony-containing compound, the amount of the bromine-containing compound is preferably 1 to 30 parts by mass and the amount of the antimony-containing compound is preferably 0.5 to 15 parts by mass each relative to 100 parts by mass of the polymer. The amount of the bromine-containing compound is more preferably 3 parts by mass or more, still more preferably 5 parts by mass or more, while more preferably 20 parts by mass or less, still more preferably 15 parts by mass or less, relative to 100 parts by mass of the polymer. The amount of the antimony compound is more preferably 1.5 parts by mass or more, still more preferably 2.5 parts by mass or more, while more preferably 10 parts by mass or less, still more preferably 7.5 parts by mass or less, relative to 100 parts by mass of the polymer.

Examples of the curing accelerator include organotin compounds, acidic phosphoric acid esters, reaction products of an acidic phosphoric acid ester and an amine, saturated or unsaturated polycarboxylic acids and acid anhydrides thereof, organotitanate compounds, amine compounds, and lead octylate.

Specific examples of the organotin compounds include dibutyltin dilaurate, dibutyltin maleate, dioctyltin maleate, dibutyltin diacetate, dibutyltin phthalate, tin octylate, tin naphthenate, and dibutyltin methoxide.

The acidic phosphoric acid esters are phosphoric acid esters containing a site represented by the following formula.

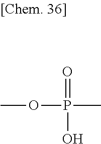

Examples thereof include organic acidic phosphoric acid esters represented by the following formula:

(R⁹—O)_{b}—P(═O)—(OH)_{3 b}

wherein b is 1 or 2; and R⁹ is an organic residue.

Specific examples thereof include those represented by the following formula.

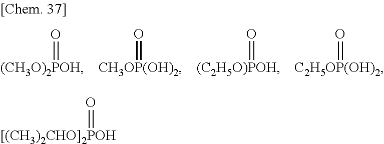

Examples of the organotitanate compounds include titanic acid esters such as tetrabutyl titanate, tetraisopropyl titanate, and triethanolamine titanate. Examples of commercially available products thereof include ORGATIX TC-100, TC-750, TC-760, and TA-30 (Matsumoto Fine Chemical Co., Ltd.).

Specific examples of the amine compounds include amine compounds such as butylamine, octylamine, dibutylamine, monoethanolamine, diethanolamine, triethanolamine, diethylenetriamine, triethylenetetramine, oleylamine, cyclohexylamine, benzylamine, diethylaminopropylamine, xylylenediamine, triethylenediamine, guanidine, diphenylguanidine, 2,4,6-tris(dimethylaminomethyl)phenol, morpholine, N-methylmorpholine, 1,8-diazabicyclo(5.4.0)undecene-7 (DBU), carboxylic acid salts thereof, low molecular weight polyamide resins obtainable from excessive amounts of a polyamine and a polybasic acid, and reaction products of excessive amounts of a polyamine and an epoxy compound.

The curing accelerators may be used alone or in combination of two or more thereof. The amount of the curing accelerator is preferably about 1.0×10⁻⁶ to 1.0×10⁻² parts by mass, more preferably about 5.0×10⁻⁵ to 1.0××10⁻³ parts by mass, relative to 100 parts by mass of the polymer.

Specific examples of the pigment include, but are not limited to, inorganic pigments such as titanium dioxide, calcium carbonate, and carbon black; and organic pigments such as phthalocyanine pigments, quinacridone pigments, and azo pigments. The upper limit of the amount of the pigment is usually about 200 parts by mass relative to 100 parts by mass of the polymer.

Examples of the hydrophilic agent include methyl silicate, ethyl silicate, fluoroalkyl silicate, and condensation products thereof. Examples of commercially available products thereof include ET40 and ET48 (Colcoat Co., Ltd.), MS56, MS56S, and MS57 (Mitsubishi Chemical Corp.), and GH700 and GH701 (Daikin Industries, Ltd.).

Examples of the flatting agent include silica, silica alumina, alumina, talc, calcium carbonate, and titanium dioxide. The amount of the flatting agent is preferably 1 to 100% by mass relative to the polymer. Examples of commercially available products thereof include Sylysia 350, Sylysia 436, Sylysia 446, Sylophobic 100, and Sylophobic 200 (Fuji Silysia Chemical Ltd.), and SYLOID ED2, SYLOID ED30, and SYLOID ED50 (W. R. Grace).

Examples of the adhesiveness promoter include various polyol additives such as polyester polyols, polycarbonate polyols, polyether polyols, and polybutadiene polyols, and silane-coupling agents. The amount of the adhesiveness promoter is preferably 0.1 to 50% by mass relative to the polymer. Examples of commercially available products thereof include FLEXOREZ 148, FLEXOREZ 188, and FLEXOREZ A308 (Kusumoto Chemicals, Ltd.), ETERNACOLL UH-50 and ETERNACOLL UM-90 (Ube Industries, Ltd.), Adeka Polyether P-400 and Adeka Polyol BPX-21 (Adeka Corp.), NISSO-PB GI-1000, GI-2000, and GI-3000 (Nippon Soda Co., Ltd.), PH-50 and PH-100 (Ube Industries, Ltd.), and Priplast-1838 and Priplast-3192 (Croda Japan KK).

The invention also relates to a coating film formed from the composition. The coating film having such a feature has excellent weather resistance and stain resistance.

The coating film can be formed by applying the composition to a substrate or another material, optionally followed by drying and curing of the composition. The drying and curing can be performed at 10° C. to 300° C., usually 100° C. to 200° C., for 30 seconds to 3 days. The dried and cured composition may be aged. The aging is usually performed at 20° C. to 300° C. and completed within 1 minute to 3 days.

In order to achieve good opacity, weather resistance, chemical resistance, and moisture resistance, the coating film preferably has a thickness of 5 μm or greater. The thickness is more preferably 7 μm or greater, still more preferably 10 μm or greater. Too thick a coating film may fail to provide an effect of weight reduction. Thus, the upper limit of the thickness is preferably about 1000 μm, more preferably about 100 μm. The thickness is particularly preferably 10 to 40 μm.

The coating film may be disposed on various substrates. A primer layer may be disposed between the base material and the coating film. Still, since the coating film has excellent adhesiveness, the substrate and the coating film may be bonded directly with sufficient adhesion strength. A laminate including the coating film and the substrate is also a preferred embodiment of the invention.

Examples of a material of the substrate include metal, ceramic, resin, and glass. The substrate may be a water-impermeable sheet described below.

Examples of the metal include iron; stainless steel such as SUS 304, SUS 316L, and SUS 403; aluminum; and plated steel sheets, such as zinc-plated or aluminum-plated steel sheets. Examples of the ceramic include earthenware, porcelain, alumina materials, zirconia materials, and silicon oxide materials. Examples of the resin include polyethylene terephthalate resin, polycarbonate resin, silicone resin, fluorosilicone resin, polyamide resin, polyamide-imide resin, polyimide resin, polyester resin, epoxy resin, polyphenylene sulfide resin, phenol resin, acrylic resin, and polyether sulfone resin. The coating film containing the polymer of the invention, the coating film obtained from the composition of the invention, and the coating film of the invention also have good initial adhesiveness to a substrate made of silicone resin, and have good adhesiveness thereto after a pressure cooker test.

The coating film of the invention and the laminate including the coating film and the substrate is suitably used as a back sheet for a solar cell module. The back sheet is suitably used as a back sheet for a solar cell module to protect the back of a solar cell module. The solar cell module usually includes a surface layer, a solar cell, an encapsulant layer for encapsulating a solar cell, and a back sheet. The back sheet is known to require properties such as mechanical strength, weather resistance, waterproof, moisture proof, and electrical insulation.

The back sheet preferably further includes a water-impermeable sheet. The water-impermeable sheet is a layer disposed so as to prevent permeation of moisture to the encapsulant and the solar cell, and may be formed from any material substantially preventing permeation of water. From the viewpoints of factors such as weight, price, and flexibility, polyethylene terephthalate (PET) sheets, SiOₓ— deposited PET sheets, and metal thin sheets of aluminum or stainless steel are often used. In particular, very often used are PET sheets. The thickness thereof is usually about 50 to 250 μm. SiOₓ-deposited PET sheets are often used for cases requiring especially moisture proofing. The thickness thereof is usually about 10 to 20 μm.

The coating film is disposed on at least one surface of the water-impermeable sheet. The coating film may be disposed on only one surface of the water-impermeable sheet, or may be disposed on each surface thereof. The water-impermeable sheet and the coating film may be bonded to each other directly or with a different layer in between. Still, they are preferably bonded to each other directly. The different layer may be a primer layer, for example.

The primer layer is formed using a conventionally known coating material for primers by a common method. Representative examples of the coating material for primers include epoxy resin, urethane resin, acrylic resin, silicone resin, and polyester resin.

In order to achieve good opacity, weather resistance, chemical resistance, and moisture resistance, the coating film preferably has a thickness of 5 μ3m or greater. The thickness is more preferably 7 μm or greater, still more preferably 10 μm or greater. Too thick a coating film may fail to provide an effect of weight reduction. Thus, the upper limit of the thickness is preferably about 1000 μm, more preferably about 100 μm. The thickness is particularly preferably 10 to 40 μm.

In order to improve the adhesiveness to the coating film, the water-impermeable sheet may be subjected to a conventionally known surface treatment. Examples of the surface treatment include corona discharge treatment, plasma discharge treatment, and chemical conversion coating, and, for metal sheets, blast treatment.

The back sheet may be used in the state of being bonded to an encapsulant layer of a solar cell module. For the back sheet including the coating film on only one side of the water-impermeable sheet, the water-impermeable sheet and the encapsulant layer may be bonded to each other, or the coating film and the encapsulant layer may be bonded to each other. Preferably, the coating film and the encapsulant layer are bonded to each other because the coating film exhibits excellent adhesiveness to the water-impermeable sheet and excellent adhesiveness to the encapsulant layer. Also, preferably, the coating film is placed on the outermost surface of the solar cell module because the coating film has excellent weather resistance. Accordingly, the back sheet preferably includes the coating film on each side of the water-impermeable sheet.

The encapsulant layer is formed from an encapsulant and encapsulates the solar cell therein. Examples of the encapsulant include ethylene/vinyl acetate copolymers (EVA), polyvinyl butyral (PVB), silicone resin, epoxy resin, and acrylic resin. Preferred is EVA.

A solar cell module including the coating film, the laminate, or the back sheet is also one embodiment of the invention.

Moreover, the coating film of the invention can be suitably used as wrapping films for vehicle bodies. Wrapping films are suitably used as films to protect the exterior of vehicle bodies. Wrapping films are known to usually require properties such as weather resistance and stain resistance for vehicle bodies.

### EXAMPLES

The invention is described hereinbelow referring to, but not limited to, reference examples.

The parameters in the reference examples were determined by the following methods.

(1) Fluorine Content

The fluorine content was determined by elemental analysis.

(2) Amounts of Respective Monomer Units Constituting Polymer

The amounts (mol %) of the respective monomer units were calculated based on the fluorine content (% by mass) determined by elemental analysis and composition analysis of the ¹H-NMR spectrum.

### (3) Hydroxyl Value

The hydroxyl value was calculated from the weight of the polymer and the number of moles of a —OH group using the actual amount and solid content of the hydroxy group-containing monomer used in the polymerization.

### Reference Example 1

A 6000-ml stainless-steel autoclave was charged with 2500 g of butyl acetate, 584 g of vinyl neononanoate (NNVE), and 527 g of 4-hydroxybutyl vinyl ether (HBVE), and purged with nitrogen under reduced pressure. Then, 658 g of tetrafluoroethylene (TFE) was put thereinto. The contents were heated to 60.0° C. under stirring, and 30 g of a peroxide-type polymerization initiator was put thereinto to initiate polymerization. The reaction was stopped when the internal pressure of the reactor was reduced from 1.0 MPaG to 0.4 MPaG. Thus, a solution containing a polymer was obtained. The composition, fluorine content, and hydroxyl value of the polymer are shown in Table 1.

To 100 parts by mass of the solution containing the polymer was added an isocyanate curing agent (Sumidur N3300, Covestro Japan Ltd.) so that the equivalent ratio (NCO/OH) between the isocyanate groups (NCO) of the isocyanate curing agent and the hydroxy groups (OH) of the polymer corresponded to the equivalent ratio shown in Table 1. In addition, AFPE shown in Table 1 was added thereto. Thus, a composition was prepared.

Each resulting composition was subjected to a weather resistance test and a permanent ink stain test, which were conducted by the following methods. The results are shown in Table 1.

### (Weather Resistance Test)

The composition was applied to an aluminum plate using a bar coater (AM713 treatment in accordance with JIS H 4000 A-1050P), and left to stand at room temperature for one week to form a cured coating film. The gloss of the coating film was evaluated in accordance with JIS K 5400. In addition, the coating film was subjected to an exposure test in a QUV accelerated weathering tester (Q-Lab Corporation) for 1000 hours. Thus, the gloss retention to the initial gloss was evaluated.

### (Permanent Ink Stain Test)

The composition was stored under the conditions shown in Table 1, applied to glass using a bar coater, and left to stand at room temperature for one week to form a cured coating film. To the coating film was applied an ink using a red permanent marker (oil based marker, large size, red, ML-T2, Teranishi Chemical Industry Co., Ltd.). The workpiece was left to stand for 24 hours. The surface to which the ink was applied was wiped with a dry paper towel (Kimtowel, Nippon Paper Crecia Co., Ltd.), and subjected to measurement of color difference (ΔE).

For ΔE, the color of the coating film was measured in the L*a*b*color system using a colorimeter available from Nippon Denshoku Industries Co., Ltd. in accordance with JIS K 5600-4-5, and AE was determined from the following equation.

ΔE=[(ΔL*)²+(Δa*)²+(Δb*)²]^{1/2}

### Reference Examples 2 to 6 and Comparative Reference Examples 1 to 5

Polymers and compositions were prepared as in Reference Example 1 and they were subjected to a weather resistance test and a permanent ink stain test, except that the components shown in Table 1 were used. The results are shown in Table 1.

TABLE 1

| | | Reference | | Reference | | Reference | | Reference | | Reference | | Reference | |
|---|---|---|---|---|---|---|---|---|---|---|---|---|---|
| | | Example 1 | | Example 2 | | Example 3 | | Example 4 | | Example 5 | | Example 6 | |
| Perhaloolefin polymer (parts by mass) | | 100 | | 100 | | 100 | | 100 | | 100 | | 100 | |
| Composition | Perhaloolefin unit | TFE | 49 | TFE | 48 | TFE | 51 | TFE | 53 | TFE | 47 | CTFE | 40 |
| (mol %) | Vinyl ester unit | NNVE | 21 | NDVE | 22 | NDVE | 18 | NDVE | 14 | NNVE | 4 | | |
| | | | | | | | | | | VAc | 26 | VAc | 10 |
| | Alkyl vinyl ether unit | | | | | | | | | | | EVE | 15 |
| | Hydroxy group- | HBVE | 30 | HBVE | 28 | HEVE | 30 | HEVE | 32 | HBVE | 23 | HEVE | 35 |
| | containing | | | | | | | | | | | | |
| | monomer unit | | | | | | | | | | | | |
| | Aromatic ring- | | | VBz | 1 | VBz | 1 | | | | | | |
| | containing vinyl | | | | | | | | | | | | |
| | ester unit | | | | | | | | | | | | |
| | Carboxy group- | | | AA | 1 | | | CA | 1 | | | | |
| | containing monomer | | | | | | | | | | | | |
| | unit | | | | | | | | | | | | |
| Phthalkyd 926-70 (Hitachi Chemical | | 0 | | 0 | | 0 | | 0 | | 0 | | 0 | |
| Co., Ltd.) (parts by mass) | | | | | | | | | | | | | |
| Fluorine content (mass %) | | 40 | | 38 | | 45 | | 48 | | 45 | | 48 | |
| Hydroxyl value (mgKOH/g) | | 137 | | 124 | | 150 | | 163 | | 127 | | 179 | |
| Antifouling | (mass % relative | AFPE | 0.3 | FZ-3705 | 0.5 | KF-6001 | 0.2 | AFPE | 2.0 | FZ-3705 | 3.0 | KF-6001 | 2.0 |
| component | to polymer) | | | | | | | | | | | | |

| Curing agent | Equivalent ratio | 1.1 | 1.1 | 1.1 | 1.1 | 1.1 | 1.1 |
|---|---|---|---|---|---|---|---|
| N-3300 | (NCO/OH) | | | | | | |
| Gloss retention | | 92% | 91% | 92% | 92% | 93% | 90% |
| ΔE after | Initial | 0.1 | 0.1 | 0.1 | 0.1 | 0.1 | 0.1 |
| wiping of | 1 week at 5° C. | 0.1 | 0.2 | 0.2 | 0.1 | 0.2 | 0.2 |
| permanent | 2 weeks at 5° C. | 0.2 | 0.2 | 0.3 | 0.1 | 0.2 | 0.2 |
| ink stain | 3 weeks at 5° C. | 0.3 | 0.3 | 0.3 | 0.1 | 0.2 | 0.4 |
| with waste | 4 weeks at 5° C. | 0.3 | 0.4 | 0.4 | 0.2 | 0.2 | 0.5 |
| cloth | 8 weeks at 5° C. | 0.5 | 0.6 | 0.6 | 0.2 | 0.3 | 0.7 |
| | 1 week at 50° C. | 0.2 | 0.2 | 0.1 | 0.1 | 0.1 | 0.2 |
| | 2 weeks at 50° C. | 0.3 | 0.3 | 0.3 | 0.2 | 0.2 | 0.2 |
| | 3 weeks at 50° C. | 0.4 | 0.3 | 0.3 | 0.2 | 0.3 | 0.4 |
| | 4 weeks at 50° C. | 0.6 | 0.4 | 0.5 | 0.3 | 0.3 | 0.5 |
| | 8 weeks at 50° C. | 0.5 | 0.5 | 0.5 | 0.4 | 0.4 | 0.7 |

| | | Comparative | | Comparative | | Comparative | | Comparative | | Comparative | |
|---|---|---|---|---|---|---|---|---|---|---|---|
| | | Reference | | Reference | | Reference | | Reference | | Reference | |
| | | Example 1 | | Example 2 | | Example 3 | | Example 4 | | Example 5 | |
| Perhaloolefin polymer (parts by mass) | | 100 | | 100 | | 0 | | 100 | | 100 | |
| Composition | Perhaloolefin unit | TFE | 44 | TFE | 37 | | | TFE | 49 | TFE | 49 |
| (mol %) | Vinyl ester unit | NDVE | 36 | | | | | NNVE | 21 | NNVE | 21 |
| | Alkyl vinyl ether unit | | | | | | | | | | |
| | Hydroxy group- | HBVE | 15 | HBVE | 45 | | | HBVE | 30 | HBVE | 30 |
| | containing | | | | | | | | | | |
| | monomer unit | | | | | | | | | | |
| | Aromatic ring- | VBz | 4 | VBz | 18 | | | | | | |
| | containing vinyl | | | | | | | | | | |
| | ester unit | | | | | | | | | | |
| | Carboxy group- | AA | 1 | | | | | | | | |
| | containing monomer | | | | | | | | | | |
| | unit | | | | | | | | | | |
| Phthalkyd 926-70 (Hitachi Chemical | | 0 | | 0 | | 100 | | 0 | | 0 | |
| Co., Ltd.) (parts by mass) | | | | | | | | | | | |
| Fluorine content (mass %) | | 32 | | 39 | | 0 | | 40 | | 40 | |
| Hydroxyl value (mgKOH/g) | | 60 | | 237 | | 160 | | 137 | | 137 | |
| Antifouling | (mass % relative | AFPE | 1.5 | FZ-3705 | 2.0 | KF-6001 | 0.2 | KF-96-100cs | 3.0 | — | 0.0 |
| component | to polymer) | | | | | | | | | | |

| Curing agent | Equivalent ratio | 1.1 | 1.1 | 1.1 | 1.1 | 1.1 |
|---|---|---|---|---|---|---|
| N-3300 | (NCO/OH) | | | | | |
| Gloss retention | | 90% | 73% | 49% | 99% | 92% |
| ΔE after | Initial | 1.2 | 1.6 | 2.0 | 3.9 | 8.8 |
| wiping of | 1 week at 5° C. | 1.5 | 1.6 | 2.6 | 4.2 | 9.6 |
| permanent | 2 weeks at 5° C. | 1.6 | 1.8 | 2.9 | 3.8 | 8.3 |
| ink stain | 3 weeks at 5° C. | 2.0 | 2.0 | 3.5 | 4.7 | 10.1 |
| with waste | 4 weeks at 5° C. | 2.3 | 2.6 | 4.0 | 4.5 | 9.0 |
| cloth | 8 weeks at 5° C. | 2.4 | 3.1 | 4.2 | 4.9 | 8.5 |
| | 1 week at 50° C. | 1.7 | 1.7 | 2.5 | 4.6 | 9.2 |
| | 2 weeks at 50° C. | 1.8 | 2.0 | 2.7 | 5.3 | 7.9 |
| | 3 weeks at 50° C. | 2.1 | 2.5 | 4.4 | 4.7 | 9.6 |
| | 4 weeks at 50° C. | 2.6 | 3.2 | 4.6 | 4.9 | 8.7 |
| | 8 weeks at 50° C. | 3.4 | 4.4 | 5.1 | 5.8 | 9.5 |

Abbreviations in the table
TFE: Tetrafluoroethylene
CTFE: Chlorotrifluoroethylene
NNVE: Vinyl neononanoate
NDVE: Vinyl neodecanoate
VBz: Vinyl benzoate
VAc: Vinyl acetate
EVE: Ethyl vinyl ether
HBVE: 4-Hydroxybutyl vinyl ether
HEVE: 2-Hydroxyethyl vinyl ether
AA: Acrylic acid
CA: Crotonic acid
AFPE: F(C₃F₆O)₁₂CF₂CF₂CH₂NH₂
FZ-3705: Modified silicone oil containing an amino group in a side chain available from Dow Corning Toray Co., Ltd.
KF-6001: Both-end carbinol-modified silicone oil available from Shin-Etsu Chemical Co., Ltd.
KF-96-100cs: Dimethylpolysiloxane available from Shin-Etsu Chemical Co., Ltd.
N-3300: Polyisocyanate available from Sumika Covestro Urethane

1. A composition comprising:
a polymer, and
at least one compound selected from the group consisting of a fluoropolyether and a reactive polydialkylsiloxane,
the polymer containing a unit of a perhaloolefin in an amount of 30 to 60 mol % and a unit of a hydroxy group-containing monomer in an amount of 15 to 35 mol % of all monomer units constituting the polymer, and having a hydroxyl value of 110 120 to 210 mgKOH/g,
the reactive polydialkylsiloxane containing a reactive site selected from the group consisting of an amino group-containing site and a hydroxy group-containing site at an end of the main chain and/or in a side chain.

2. The composition according to claim 1,
wherein the perhaloolefin is at least one selected from the group consisting of tetrafluoroethylene, chlorotrifluoroethylene, and hexafluoropropylene.

3. The composition according to claim 1,
wherein the hydroxy group-containing monomer is a hydroxyalkyl vinyl ether.

4. The composition according to claim 1,
wherein the polymer further contains a unit of a vinyl ester that contains neither a hydroxy group nor an aromatic ring.

5. The composition according to claim 4,
wherein the vinyl ester is at least one selected from the group consisting of vinyl acetate, vinyl propionate, vinyl butyrate, vinyl isobutyrate, vinyl pivalate, vinyl caproate, vinyl versatate, vinyl laurate, vinyl stearate, and vinyl cyclohexylcarboxylate.

6. The composition according to claim 1,
wherein the reactive polydialkylsiloxane contains no polyether group.

7. The composition according to claim 1,
wherein the reactive polydialkylsiloxane is at least one selected from the group consisting of:
a compound represented by the following formula (I): 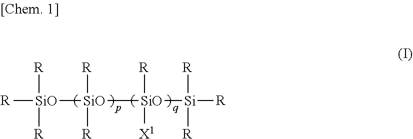
wherein each R is independently a C1-C8 alkyl group or an aryl group;
X¹ is
—R^{L}—NH₂,
—R^{L}—NH—R^{a1}—NH₂, where R^{a1} is an alkylene group,
—R^{L}—OR^{a2}, where R^{a2} is H or an alkyl group,
—R^{L}—CR^{a3}(R^{a4}OH)₂, where R^{a3} is an alkyl group and R^{a4} is an alkylene group,
—R^{L}—Ar¹—OR^{a5}, where Ar¹ is an arylene group and R^{a5} is H or an alkyl group,
—R^{L}—O(C═O)—CR^{a6}═CH₂, where R^{a5} is H or an alkyl group,
—R^{L}—SH,
—R^{L}—COOR^{a7}, where R^{a7} is H or an alkyl group,
—H, 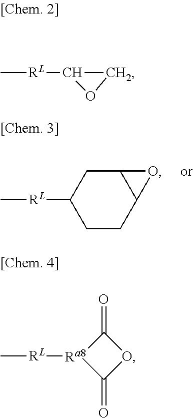
wherein R^{a8} is a trivalent hydrocarbon group, wherein each R^{L} is a single bond or an alkylene group not containing two or more ether bonds, with any of X¹s being optionally —R^{L}—(C₂H₄O)ₐ(C₃H₆O)_{b}—R^{a9}, wherein R^{L} is as defined above, R^{a9} is an alkyl group, a is an integer of 0 to 50, and b is an integer of 0 to 50, with a+b being an integer of 2 or greater; p is an integer of 0 to 100000; and q is an integer of 1 to 100000: and a compound represented by the following formula (II): 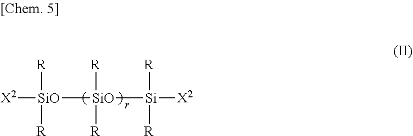
wherein each R is as defined above; each X² is independently the same as X¹ defined above or —R^{L}—(C₂H₄O)ₐ(C₃H₆O)_{b}—H(R^{L}, a, and b are as defined above); and r is an integer of 1 to 100000.

8. The composition according to claim 1,
wherein the reactive polydialkylsiloxane has a specific gravity of 0.80 to 1.15.

9. The composition according to claim 1,
wherein the reactive polydialkylsiloxane has a refractive index of 1.370 to 1.540.

10. The composition according to claim 1,
wherein the fluoropolyether is a compound represented by the formula:
R¹¹—(R¹²O)ₙ—R¹³
wherein R¹¹ and R¹³ are each independently H, F, a C1-C16 alkyl group, a C1-C16 alkoxy group, a C1-C16 fluorinated alkyl group, a C1-C16 fluorinated alkoxy group, or —R¹⁴—X¹¹ (R¹⁴ is a single bond or a divalent organic group, X¹¹ is —NH₂, —OH, —COOH, —CH═CH₂, —OCH₂CH═CH₂, a halogen atom, a phosphate group, a phosphoric acid ester group, an alkoxycarbonyl group, a thiol group, a thioether group, an aryl group, an aryl ether group, or an amino group); R¹² is a C1-C4 fluorinated alkylene group; and n is an integer of 2 or greater.

11. The composition according to claim 1, further comprising a polyisocyanate compound.

12. The composition according to claim 1, further comprising a solvent.

13. A coating film formed from the composition according to claim 1.
